(19) United States
(12) Patent Application Publication
(10) Pub. No.: US 2025/0084197 A1
(43) Pub. Date: Mar. 13, 2025

(54) ACRYLIC RESIN COMPOSITIONS

(71) Applicant: PPG Architectural Finishes, Inc., Pittsburgh, PA (US)

(72) Inventors: Allison Gamble Condie, Valencia, PA (US); Qi Zheng, Wexford, PA (US); Theodore F. Novitsky, Jr., Butler, PA (US); Kenneth T. Phelps, New Kensington, PA (US); Jamie Andrew Nowalk, Crafton, PA (US); Susan F. Donaldson, Allison Park, PA (US)

(73) Assignee: PPG Architectural Finishes, Inc., Pittsburgh, PA (US)

(21) Appl. No.: 18/725,213

(22) PCT Filed: Dec. 20, 2022
(86) PCT No.: PCT/US2022/082044

§ 371 Date: Jun. 28, 2024

Related U.S. Application Data
(60) Provisional application No. 63/295,428, filed on Dec. 30, 2021.

(51) Int. Cl. C08F 220/18; C09D 143/04; C09J 143/04

(52) U.S. Cl. CPC C08F 220/1804; C09D 143/04; C09J 143/04

(57) ABSTRACT

Disclosed herein are resin compositions comprising a (meth)acrylic polymer comprising at least one pendant silane functional group and a silane functional group equivalent weight of 500 g/eq to 9,000 g/eq. Also disclosed herein are coating compositions comprising any of the resin compositions disclosed herein and an accelerator. Also disclosed herein are coating compositions comprising a resin composition comprising a (meth)acrylic polymer comprising at least one pendant silane functional group; and an accelerator. Also disclosed are substrates comprising a coating formed on a surface from compositions disclosed herein. Also disclosed are uses of the compositions disclosed herein.

### CROSS-REFERENCE TO RELATED APPLICATIONS

This application claims priority to U.S. Provisional Application No. 63/295,428, filed on Dec. 30, 2021 and titled “Acrylic Resin Compositions,” incorporated herein by reference in its entirety.

### FIELD

The present disclosure relates to moisture-curable silane acrylic resins for use in adhesives and sealants.

### BACKGROUND

Silane resins are widely used in sealants and adhesives. Such sealants and adhesives may be used on a variety of surfaces such as wood, galvanized steel, aluminum, sheet rock, foam board, ceramic, glass, and the like. The present invention is directed to silane resins that are used to produce sealants and adhesives that have sufficient bond strength and are easy to apply for use in bonding together substrate materials.

### SUMMARY

Disclosed herein is a resin composition comprising a (meth)acrylic polymer comprising at least one pendant silane functional group and a silane functional group equivalent weight of 500 g/eq to 9,000 g/eq.

Also disclosed herein is a coating composition comprising: a resin composition comprising a (meth)acrylic polymer comprising at least one pendant silane functional group; and an accelerator.

Also disclosed herein is an article comprising a first substrate, a second substrate, and a composition comprising one of the resin compositions disclosed herein in an at least partially cured state positioned between the first substrate and the second substrate.

Also disclosed herein is an article comprising a first substrate, a second substrate, and one of the coating compositions disclosed herein in an at least partially cured state positioned between the first substrate and the second substrate.

Also disclosed herein is a method of forming a bond between two substrates comprising: applying an adhesive composition comprising one of the resin compositions disclosed herein to a first substrate and contacting a second substrate to the adhesive composition such that the adhesive composition is located between the first substrate and the second substrate.

Also disclosed herein is a method of forming a bond between two substrates comprising: applying one of the adhesive compositions disclosed herein to a first substrate and contacting a second substrate to the adhesive composition such that the adhesive composition is located between the first substrate and the second substrate.

### BRIEF DESCRIPTION OF THE DRAWINGS

FIG. 1 is a scatterplot showing adhesive shear strength (psi) of the adhesive compositions 28 to 30 and comparative examples 15 to 21 as a function of crosslink density (mmol/cc) of the adhesive compositions 28 to 30 and comparative examples 15 to 21.

FIG. 2 is a scatterplot showing adhesive shear strength (psi) of the adhesive compositions 28 to 30 and comparative examples 15 to 21 as a function of Tg (° C.) of the adhesive compositions 28 to 30 and comparative examples 15 to 21.

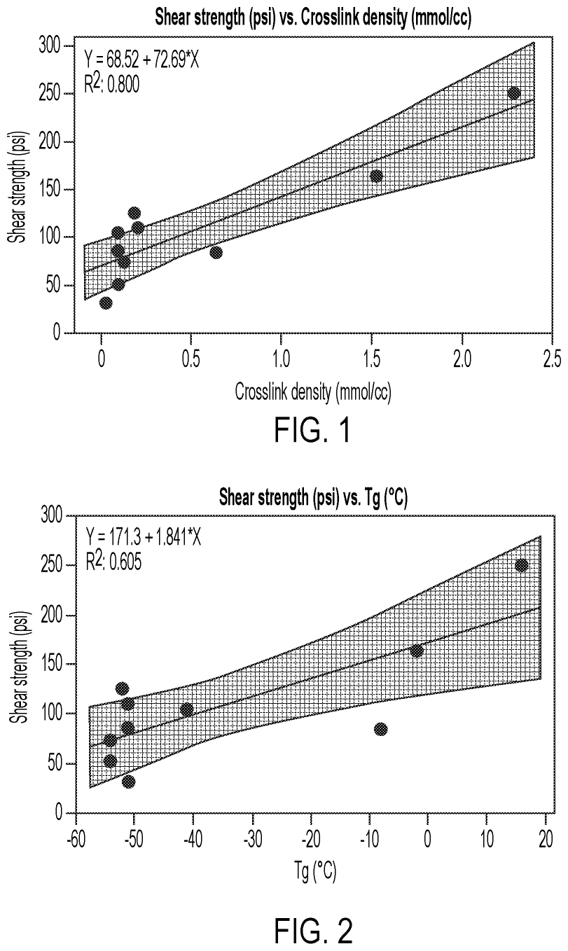

### DETAILED DESCRIPTION

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters set forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

In this application, the use of the singular includes the plural and the plural encompasses the singular, unless specifically stated otherwise. For example, although reference is made herein to “a” (meth)acrylic polymer, “a” catalyst, and “a” filler material, a combination (i.e., a plurality) of these components may be used.

In addition, in this application, the use of “or” means “and/or” unless specifically stated otherwise, even though “and/or” may be explicitly used in certain instances.

As used herein, the terms “on,” “onto,” “applied on,” “applied onto,” “formed on,” “deposited on,” “deposited onto,” and the like mean formed, overlaid, deposited, or provided on, but not necessarily in contact with, a substrate surface. For example, a composition “applied onto” a substrate surface does not preclude the presence of one or more other intervening coating layers or films of the same or different composition located between the composition and the substrate surface.

As used herein, a “coating composition” refers to a composition, e.g., a solution, mixture, or a dispersion, that, in an at least partially dried or cured state, is capable of producing a film, layer, or the like on at least a portion of a substrate surface.

As used herein, a “sealant” or “sealant composition” refers to a coating composition, e.g., a solution, mixture, or a dispersion, that, in an at least partially dried or cured state, has the ability to resist atmospheric conditions and particulate matter, such as moisture and temperature and at least partially block the transmission of materials, such as particulates, water, fuel, and other liquids and gasses.

As used herein, an “adhesive” or “adhesive composition” refers to a coating composition, e.g., a solution, mixture, or a dispersion that, in an at least partially dried or cured state, produces a load-bearing joint, such as a load-bearing joint having a compression shear strength of at least 50 pounds per square inch (psi), as determined according to ASTM D-905 using an Instron 5567 or 5569 machine fitted with a wood shear fixture model S1-11857-2 in compression mode with a rate of 0.2 inches per minute.

As used herein, the term “one component” or “1K” refers to a composition in which all of the ingredients may be premixed and stored and wherein the reactive components do not readily react when stored under conditions that are substantially free of moisture, but instead react only upon exposure to moisture or water present in the atmosphere, present on the substrate, purposefully added to the composition, and/or bound to an ingredient of the composition. The composition remains “workable” for at least 10 days, such as at least 30 days, such as at least 90 days after mixing under conditions substantially free of moisture and at ambient temperatures. As used herein, the term “workable” means that the composition is of a viscosity that is able to be deformed and/or shaped under manual pressure.

As used herein, “free of moisture” and “substantially free of moisture” means that although the composition may contain some moisture, the amount of moisture is not sufficient enough to cause the viscosity of the composition to double (measured at a shear rate of 100 s¹ on an Anton Paar MCR 92 rheometer at 25° C. using a 15 mm diameter parallel plate and a 0.5 mm gap) in at least 10 days, such as at least 30 days, such as at least 90 days.

As further defined herein, ambient conditions generally refer to room temperature and humidity conditions or temperature and humidity conditions that are typically found in the area in which the composition is applied to a substrate, e.g., at 10° C. to 40° C. and 5% to 80% relative humidity.

As used herein, the term “two-component” or “2K” refers to a composition in which at least a portion of the reactive components readily associate to form an interaction or react to form a bond (physically or chemically), and at least partially cure upon exposure to moisture or water, wherein the moisture or water derives from moisture or water present in the atmosphere, present on the substrate, purposefully added to the composition, and/or bound to an ingredient of the composition. One of skill in the art understands that the two components of the composition are stored separately from each other and mixed just prior to application of the composition.

As used herein, the term “curing agent” means any reactive material that can be added to a composition to cure the composition. As used herein, the term “cure,” “cured,” or similar terms, means that the reactive functional groups of the components that form the composition react to form a film, layer, or bond. As used herein, the term “at least partially cured” means that at least a portion of the components that form the composition interact, react, and/or are crosslinked to form a film, layer, or bond. As used herein, “curing” of the curable composition refers to subjecting said composition to curing conditions leading to reaction of the reactive functional groups of the components of the composition and resulting in the crosslinking of the components of the composition and formation of an at least partially cured film, layer, or bond. As used herein, a “curable” composition refers to a composition that may be cured. In the case of a 1K composition, the composition is at least partially cured when the composition is subjected to curing conditions that lead to the reaction of the reactive functional groups of the components of the composition, such as exposure to moisture or water. A curable composition is at least partially cured or cured when the composition is subjected to curing conditions that lead to the reaction of the reactive functional groups of the components of the composition. In the case of a 2K composition, the composition is at least partially cured or cured when the components of the composition are mixed to lead to the reaction of the reactive functional groups of the components of the composition.

As used herein, “polymer” refers to oligomers, homopolymers, and copolymers.

As used herein, the term “(meth)acrylate” refers to either/or methacrylate or acrylate in a monomer form and “(meth)acrylic,” “methacrylic acid,” or “acrylic acid” refers to a polymer comprising monomers comprising (meth)acrylate.

As used herein, “pendant” or “pendant group” means a functional group that is bonded to the backbone of the polymer.

As used herein, “backbone” means the longest series of covalently bound atoms, which forms the continuous chain of the polymer.

As used herein, “functional group” means specific groups of atoms within a molecule that have the potential to undergo chemical reactions under certain conditions, regardless of the other atoms in the molecule.

As used herein, a “non-silane acrylic monomer” or “non-silane acrylic functional group” means a molecule that comprises an acrylate functional group and is completely free of a silane functional group.

As used herein, “hydrolysable component” refers to a component having at least one terminal or sidechain hydrolysable group. As used herein, “hydrolysable group” refers to a functional group that is capable of undergoing hydrolysis.

As used herein, “residue” refers to a single molecular unit resulting from incorporation of a monomer into the backbone or a side chain of a polymer. The residue is smaller than the original monomer due to elimination of small molecules, such as hydrogen or water, that results from incorporation of the monomer into the polymer. For example, when a monomer HOROH is incorporated into a polymer, the residue is —R—O— and forms part of the polymer structure after removal of a water during the reaction incorporating the monomer into the polymer.

As used herein, “accelerator” means a substance that increases the rate or decreases the activation energy of a chemical reaction. An accelerator may be either a “catalyst,” that is, without undergoing any permanent chemical change, or may be a “curing agent” which is reactive, that is, capable of chemical reactions and includes any level of reaction from partial to complete reaction of a reactant.

As used herein, the term “solvent” refers to a molecule or a compound that has a high vapor pressure such as at least 2 mm Hg at 25° C. determined by differential scanning calorimetry according to ASTM E1782 and is used to lower the viscosity of a resin or composition but that does not have a reactive functional group capable of reacting with a functional group(s) on molecules or compounds in a composition under standard curing conditions.

As used herein, the term “diluent” refers to a molecule or a compound that has low vapor pressure such as less than 2 mm Hg at 25° C. determined by differential scanning calorimetry according to ASTM E1782 and will lower the viscosity of a resin or composition. As used herein, a “nonreactive diluent” means a diluent that does not have a reactive functional group capable of reacting with a functional group(s) on molecules or compounds in a composition. As used herein, a “reactive diluent” means a diluent that has a functional group(s) capable of reacting with a functional group(s) on molecules or compounds in a composition.

As used herein, “plasticizer” means a nonreactive diluent.

As used herein, “glass transition temperature” or “Tg” means the temperature at which the polymer or polymer-containing composition changes from a rigid glassy material to a soft material. One skilled in the art would understand that glass transition occurs over a range of temperatures and that the recited value is an approximation of the center of that range.

As used herein, “uncured Tg” means the glass transition temperature of a polymer or polymer-containing composition in an uncured state.

As used herein, “cured Tg” means the glass transition temperature of a polymer or polymer-containing composition in an at least partially cured state.

As used herein, “thixotrope” means a substance added to the composition so that viscosity of the composition decreases when shear or stress is applied.

As used herein, “crosslink density” means the average number of crosslinked points within or between polymer chains per unit of volume. Crosslinked points are new covalent or ionic chemical bonds formed between functional groups during cure.

As used herein, “Mw” refers to the weight average molecular weight as determined by Gel Permeation Chromatography using Waters 2695 separation module with a Waters 410 differential refractometer (RI detector), polystyrene standards, using tetrahydrofuran (THF) used as the eluent at a flow rate of 1 ml min⁻¹ and two PL Gel Mixed C columns for separation.

As used herein, “Mn” refers to the number average molecular weight as determined by Gel Permeation Chromatography using Waters 2695 separation module with a Waters 410 differential refractometer (RI detector), polystyrene standards, using tetrahydrofuran (THF) used as the eluent at a flow rate of 1 ml min⁻¹ and two PL Gel Mixed C columns for separation.

As used herein, unless indicated otherwise, the term “substantially free” means that a particular material is not purposefully added to a mixture or composition, respectively, and is only present as an impurity in a trace amount of less than 5% by weight based on a total weight of the mixture or composition, respectively. As used herein, unless indicated otherwise, the term “essentially free” means that a particular material is only present in an amount of less than 2% by weight based on a total weight of the mixture or composition, respectively. As used herein, unless indicated otherwise, the term “completely free” means that a mixture or composition, respectively, does not comprise a particular material, i.e., the mixture or composition comprises 0% by weight of such material.

As mentioned above, the present disclosure is directed to a resin composition comprising, or consisting essentially of, or consisting of, a (meth)acrylic polymer comprising at least one pendant silane functional group; and a silane functional group equivalent weight of 500 g/eq to 9,000 g/eq.

The (meth)acrylic polymer may comprise a residue of one or more ethylenically unsaturated monomers, including the ethylenically unsaturated monomer comprising a silane functional group comprising at least one alkoxy substituent, aryloxy substituent, and/or hydroxyl substituent. The (meth)acrylic polymer may be prepared by polymerizing a reaction mixture of alpha, beta-ethylenically unsaturated monomers that comprise one or more ethylenically unsaturated monomers. The (meth)acrylic polymer may comprise a reaction product of reactants comprising (i) a silane functional monomer or a polymer comprising the residue of a silane functional monomer and (ii) a non-silane acrylic monomer or polymer comprising the residue of a non-silane acrylic monomer.

As used herein, a “silane functional group” refers to an organosilicon group that comprises organic substituents. The silane functional group may comprise at least one alkoxy substituent, aryloxy substituent, and/or hydroxyl substituent and may be represented by the general formula —SiR¹ₐ X₃₋ₐ wherein R¹ represents a substituted or unsubstituted hydrocarbon group with 1 to 20 carbon atoms, each X independently represents a hydroxyl group or a hydrolysable group wherein at least one X is an alkoxy group, an aryloxy group, and/or a hydroxyl group, and a is 0, 1, or 2. Accordingly, the silane functional group may comprise one alkoxy substituent, two alkoxy substituents, three alkoxy substituents, or any combination thereof, and the polymer may comprise an ethylenically unsaturated monomer comprising one or more silane functional groups comprising one alkoxy substituent, a silane functional group comprising two alkoxy substituents, a silane functional group comprising three alkoxy substituents, or any combination thereof. The silane functional group may comprise one aryloxy substituent, two aryloxy substituents, three aryloxy substituents, or any combination thereof, and the polymer may comprise an ethylenically unsaturated monomer comprising a silane functional group comprising one aryloxy substituent, two aryloxy substituents, three aryloxy substituents, or any combination thereof. The silane functional group may comprise one hydroxyl substituent, two hydroxyl substituents, three hydroxyl substituents, or any combination thereof, and the polymer may comprise an ethylenically unsaturated monomer comprising a silane functional group comprising one hydroxyl substituent, two hydroxyl substituents, three hydroxyl substituents, or any combination thereof. The silane functional group may comprise at least one alkoxy substituent, aryloxy substituent, and/or hydroxyl substituent; two alkoxy substituents, aryloxy substituents, and/or hydroxyl substituents; three alkoxy substituents, aryloxy substituents, and/or hydroxyl substituents; or any combination thereof.

The (meth)acrylic polymer may have a silane functional group equivalent weight of at least 500 g/eq, such as at least 1,000 g/eq, such as at least 1,500 g/eq. The (meth)acrylic polymer may have a silane functional group equivalent weight of no more than 9,000 g/eq, such as no more than 8,000 g/eq, such as no more than 6,000 g/eq, such as no more than 5,500 g/eq. The (meth)acrylic polymer may have a silane functional group equivalent weight of 500 g/eq to 9,000 g/eq, such as 1,000 g/eq to 8,000 g/eq, such as 1,500 g/eq to 6,000 g/eq, such as 1,000 g/eq to 5,500 g/eq. As used herein, the silane functional group equivalent weight refers to a theoretical value determined by dividing the total theoretical weight of the (meth)acrylic polymer by the total number of equivalents of silane functional groups theoretically present therein.

The (meth)acrylic polymer may comprise the silane functional group in an amount of at least 0.2 mol % based on the total moles of functional groups of the (meth)acrylic polymer, such as at least 1 mol %, such as at least 2 mol %. The (meth)acrylic polymer may comprise the silane functional group in an amount of no more than 40 mol % based on the total moles of functional groups of the (meth)acrylic polymer, such as no more than 30 mol %, such as no more than 20 mol %, such as no more than 10 mol %. The (meth)acrylic polymer may comprise the silane functional group in an amount of 0.2 mol % to 40 mol % based on the total moles of functional groups of the (meth)acrylic polymer, such as 1 mol % to 30 mol %, such as 2 mol % to 20 mol %, such as 2 mol % to 10 mol %.

The (meth)acrylic polymer may comprise the silane functional group in an amount of at least 1% by weight based on the total Mw of the (meth)acrylic polymer, such as at least 2% by weight, such as at least 3% by weight, such as at least 4% by weight. The (meth)acrylic polymer may comprise the silane functional group in an amount of no more than 50% by weight based on the total Mw of the (meth)acrylic polymer, such as no more than 45% by weight, such as no more than 40% by weight, such as no more than 30% by weight, such as no more than 25% by weight. The (meth)acrylic polymer may comprise the silane functional group in an amount of 1% to 50% by weight based on the total Mw of the (meth)acrylic polymer, such as 2% to 45% by weight, such as 3% to 40% by weight, such as 4% to 30% by weight, such as 4% to 25% by weight.

The (meth)acrylic polymer may comprise non-silane acrylic functional groups. The non-silane acrylic functional groups may comprise a residue of alkyl esters of (meth)acrylic acid, ethylenically unsaturated monomers comprising one or more active hydrogen groups, ethylenically unsaturated monomers comprising a heterocyclic group, ethylenically unsaturated monomers comprising a silane functional group, as well as other ethylenically unsaturated monomers, including combinations thereof.

As stated herein above, the non-silane acrylic monomers may optionally comprise a residue of an alkyl ester of (meth)acrylic acid. Non-limiting examples of alkyl esters of (meth)acrylic acid include methyl (meth)acrylate, ethyl (meth)acrylate, propyl (meth)acrylate, butyl (meth)acrylate, hexyl (meth)acrylate, octyl (meth)acrylate, isodecyl (meth)acrylate, stearyl (meth)acrylate, 2-ethylhexyl (meth)acrylate, decyl (meth)acrylate, and dodecyl (meth)acrylate.

The non-silane acrylic monomers may optionally comprise a residue of a hydroxyalkyl ester. Non-limiting examples of hydroxyalkyl esters include hydroxyethyl (meth)acrylate, hydroxypropyl (meth)acrylate, and hydroxybutyl (meth)acrylate. The inclusion of a residue of a hydroxyalkyl ester in the (meth)acrylic polymer results in a (meth)acrylic polymer comprising at least one hydroxyl group (although hydroxyl groups may be included by other methods).

The (meth)acrylic polymer may comprise the non-silane acrylic monomer in an amount of at least 60 mol %, such as at least 70 mol %, such as at least 80 mol %, such as at least 90 mol %, based on the total moles of functional groups of the (meth)acrylic polymer. The (meth)acrylic polymer may comprise the non-silane acrylic monomer in an amount of no more than 99.8 mol %, such as no more than 99.5 mol %, such as no more than 99 mol %, such as no more than 98 mol %, based on the total moles of functional groups of the (meth)acrylic polymer. The (meth)acrylic polymer may comprise the non-silane acrylic monomer in an amount of 60 mol % to 99.8 mol %, such as 70 mol % to 99.5 mol %, such as 80 mol % to 99 mol %, such as 90 mol % to 98 mol %, based on the total moles of functional groups of the (meth)acrylic polymer.

The (meth)acrylic polymer may comprise the non-silane acrylic monomer in an amount of at least 50% by weight, such as at least 55% by weight, such as at least 60% by weight, such as at least 70% by weight, such as at least 75% by weight, based upon the total weight of the (meth)acrylic polymer. The (meth)acrylic polymer may comprise the non-silane acrylic monomer in an amount of no more than 99% by weight, such as no more than 98% by weight, such as no more than 97% by weight, such as no more than 96% by weight, such as no more than 95% by weight. The (meth)acrylic polymer may comprise the non-silane acrylic monomer in an amount of 50% to 99% by weight, such as 55% to 98% by weight, such as 60% to 97% by weight, such as 70% to 96% by weight, such as 75% to 95% by weight, based upon total weight of the (meth)acrylic polymer.

The (meth)acrylic polymer optionally may comprise a residue of an ethylenically unsaturated monomer comprising a heterocyclic group. Non-limiting examples of ethylenically unsaturated monomers comprising a heterocyclic group include epoxy functional ethylenically unsaturated monomers (e.g., glycidyl (meth)acrylate), vinyl pyrrolidone, vinyl caprolactam, and 2-methyl-3-((5-methyl-2-vinyl-1,3,2-dioxasilinan-2-yl)oxy)propan-1-ol, among others.

The (meth)acrylic polymer optionally may comprise a residue of a vinyl aromatic compound. Non-limiting examples of vinyl aromatic compounds includes styrene, alpha-methyl styrene, alpha-chlorostyrene and vinyl toluene.

The (meth)acrylic polymer optionally may comprise a residue of a vinyl ester monomer. As used herein, a “vinyl ester” monomer refers to a compound having the structure C═C—O—C(O)—R, wherein R is an alkyl group having 1 to 5 carbon atoms. Non-limiting examples of vinyl ester monomers include vinyl acetate, vinyl propionate, and the like.

The (meth)acrylic polymer may optionally comprise a residue of acrylamide. As used herein, “acrylamide” is a compound having the structure CH2═CHC(O)NH₂.

The (meth)acrylic polymer may have an Mw of at least 1,500 g/mol, such as at least 2,000 g/mol, such as at least 2,500 g/mol, such as at least 3,000 g/mol. The (meth)acrylic polymer may have an Mw of no more than 35,000 g/mol, such as no more than 30,000 g/mol, such as no more than 25,000 g/mol, such as no more than 20,000 g/mol. The (meth)acrylic polymer may have an Mw of 1,500 g/mol to 35,000 g/mol, such as 2,000 g/mol to 30,000 g/mol, such as 2,500 g/mol to 25,000 g/mol, such as 3,000 g/mol to 20,000 g/mol measured by gel permeation chromatography (GPC) using polystyrene standards and waters Styragel column in THF solvent. It will be understood by those of ordinary skill in the art that the Mw of the polymer will vary based upon the method of polymerization.

In examples, the (meth)acrylic polymer may be substantially free, essentially free, or completely free of ether residues, urethane residues, and/or nitrogen atoms.

In examples, the (meth)acrylic polymer may comprise a urethane residue. The urethane residue may be pendant and/or part of the polymer backbone. In examples, the polymer may be substantially free of pendant urethane linkages.

Suitable polyurethanes that may be used include those formed from a polyisocyanate, an active hydrogen-containing material, such as a polyol, a polyether, a polyester, a polycarbonate, a polyamide, a polyurethane, a polyurea, a polyamine, a polyolefin, a siloxane polyol and/or mixtures thereof. The polyurethane may, for example, comprise a reaction product of reactants comprising a polyether comprising at least one hydroxy-functional group and an isocyanate-containing compound.

As used herein, the term “isocyanate” includes isocyanate compounds capable of forming a covalent bond with a reactive group such as a hydroxyl, thiol or amine functional group. The isocyanate may be monofunctional (containing one isocyanate functional group (NCO)), or the isocyanate may be polyfunctional (containing two or more isocyanate functional groups) (NCO)).

Isocyanates suitable for use in the resin composition may include, but are not limited to, isophorone diisocyanate (IPDI), which is 3,3,5-trimethyl-5-isocyanate-methyl-cyclohexyl isocyanate; a hydrogenated substance such as cyclohexyl diisocyanate, 4,4′-methylene dicyclohexyl diisocyanate (H₁₂ MDI); a mixed aryl alkyl diisocyanate such as Tetramethylxylylene diisocyanate, OCN—C(CH₃)₂-C₆H₄C(CH₃)₂—NCO; polymethylene isocyanate, such as 1,4-butane diisocyanate, 1,5-pentane diisocyanate, 1,6-hexane diisocyanate (HMDI), 1,7-heptane diisocyanate, 2,2,4-trimethyl diisocyanate hexanediester and 2,4,4-trimethylhexyl diisocyanate, 1,10-decane diisocyanate, and 2-methyl-1,5-pentane diisocyanate; and mixtures thereof.

Useful non-limiting examples of the aromatic isocyanate may include, but are not limited to, diphenyl isocyanate; phenyl isocyanate; toluene diisocyanate (TDI); xylyl diisocyanate; 1,5-naphthalene diisocyanate; 2,4-diisocyanatochlorophenyl phenyl ester; toluidine diisocyanate; alkylated phenyl diisocyanate a methylene interrupted aromatic diisocyanate such as methylene diphenyl diisocyanate; an alkylated analog comprising a 4,4′-isomer (MDI), such as 3,3′-dimethyl Base-4,4′-diphenylmethane diisocyanate; polymerized methylene diphenyl diisocyanate; and mixtures thereof.

The isocyanate may comprise an oligomeric isocyanate such as, but not limited to, a dimer such as a uretdione ring of 1,6-hexane diisocyanate; a terpolymer, biuret and isocyanurate such as 1,6-hexane diisocyanate, and isocyanurate of isophorone diisocyanate, urethane and polymerized oligomer. Modified isocyanates can also be used including, but not limited to, carbodiimides and ureton-imines, and mixtures thereof. Suitable materials include, without limitation, those materials available from Covestro AG (Pittsburgh, PA) under the name DESMODUR, and include DESMODUR N 3200, DESMODUR N 3300, DESMODUR N 3400, DESMODUR XP 2410, and DESMODUR XP 2580.

In some embodiments, the isocyanate component comprises an isocyanate functional prepolymer formed from a reaction mixture comprising an isocyanate and another material. Any isocyanate known in the art, such as any of the materials described above, can be used to form the prepolymer. As used herein, “isocyanate functional prepolymer” refers to the reaction product of an isocyanate with a polyamine and/or other isocyanate-reactive groups, such as a polyalcohol; the isocyanate-functional prepolymer has at least one isocyanate functional group. (NCO). The polyisocyanate may comprise at least one silane functional group.

The polyurethane may be formed from an active hydrogen-containing material, such as a polyol, a polyether, a polyester, a polycarbonate, a polyamide, a polyurethane, a polyurea, a polyamine, a polyolefin, a siloxane polyol and/or mixtures thereof.

If present at all, the resin composition may comprise the polyurethane in an amount of at least 10 percent by weight based on total weight of the resin composition, such as at least 15 percent by weight, such as at least 20 percent by weight. The resin composition may comprise the polyurethane in an amount of no more than 90 percent by weight, such as no more than 70 percent by weight, such as no more than 60 percent by weight. The resin composition may comprise the polyurethane in an amount of 10 percent by weight to 90 percent by weight based on total weight of the resin composition, such as 15 percent by weight to 70 percent by weight, such as 20 percent by weight to 60 percent by weight.

The resin composition may comprise the (meth)acrylic polymer in an amount of at least 10 percent by weight based on total weight of the resin composition, such as at least 15 percent by weight, such as at least 20 percent by weight, such as at least 50 percent by weight, such as at least 70 percent by weight, such as at least 80 percent by weight, such as at least 90 percent by weight, such as at least 95 percent by weight, such as at least 98 percent by weight, such as at least 99 percent by weight. The resin composition may comprise the (meth)acrylic polymer in an amount of no more than 100 percent by weight based on total weight of the resin composition, such as no more than 90 percent by weight, such as no more than 70 percent by weight, such as no more than 60 percent by weight. The resin composition may comprise the (meth)acrylic polymer in an amount of 10 percent by weight to 100 percent by weight based on total weight of the resin composition, such as 10 percent by weight to 90 percent by weight, such as 15 percent by weight to 70 percent by weight, such as 20 percent by weight to 60 percent by weight, such as 90 percent by weight to 100 percent by weight, such as 95 percent by weight to 100 percent by weight, such as 98 percent by weight to 100 percent by weight, such as 99 percent by weight to 100 percent by weight.

at least 10 percent by weight based on total weight of the resin composition, such as at least 15 percent by weight, such as at least 20 percent by weight. The resin composition may comprise the (meth)acrylic polymer in an amount of no more than 100 percent by weight based on total weight of the resin composition, such as no more than 90 percent by weight, such as no more than 70 percent by weight, such as no more than 60 percent by weight. The resin composition may comprise the (meth)acrylic polymer in an amount of up to 100 percent by weight based on total weight of the resin composition, such as 10 percent by weight to 100 percent by weight, such as 10 percent by weight to 90 percent by weight, such as 15 percent by weight to 70 percent by weight, such as 20 percent by weight to 60 percent by weight.

The resin composition may have an uncured Tg value of at least −60° C., such as at least −50° C., such as at least −40° C., such as at least −30° C. The resin composition may have an uncured Tg value of no more than 30° C., such as no more than 25° C., such as no more than 20° C., such as no more than 10° C. The resin composition may have an uncured Tg value of −60° C. to 30° C., such as −50° C. to 25° C., such as −40° C. to 20° C., such as −30° C. to 10° C.

The (meth)acrylic polymer may be prepared by conventional free radical initiated solution polymerization techniques in which the polymerizable monomers are dissolved in an organic medium comprising a solvent or a mixture of solvents and polymerized in the presence of a free radical initiator until conversion is complete.

Examples of free radical initiators are those which are soluble in the mixture of monomers or organic medium such as azobisisobutyronitrile, azobis(alpha, gamma-methylvaleronitrile), tertiary-butyl perbenzoate, tertiary-butyl peracetate, benzoyl peroxide, ditertiary-butyl peroxide, ditertiary-amyl peroxide, and tertiary amyl peroxy 2-ethylhexyl carbonate.

Optionally, a chain transfer agent which is soluble in the mixture of monomers such as alkyl mercaptans, for example, tertiary-dodecyl mercaptan and/or mercaptopropyltrimethoxysilane; ketones such as methyl ethyl ketone; and chlorohydrocarbons such as chloroform can be used. A chain transfer agent provides control over the molecular weight to give products having required viscosity for various coating applications. A chain transfer agent will form a chemical bond at the terminal of the polymer backbone.

To prepare the addition polymer, the solvent may be first heated to reflux and the mixture of polymerizable monomers and the free radical initiator may be separately added slowly to the refluxing solvent. The reaction mixture is then held at polymerizing temperatures so as to reduce the free monomer content, such as to below 1.0% and usually below 0.5%, based on the total weight of the mixture of polymerizable monomers.

The (meth)acrylic polymer may be prepared by a continuous stirred tank reactor process. For example, monomer, initiator, and optional solvent may be added to a first continuous stirred-tank reactor and held under elevated temperature and pressure for a pre-determined residence time; the product may then be continuously fed into a second continuous stirred tank reactor and can be combined with addition monomer and initiator and held under elevated temperature and pressure for a predetermined residence time; and the product of the second continuous stirred tank reactor may then be continuously fed into a collection vessel at a rate that maintained a constant fill level in the second continuous stirred reaction tank reactor as monomer and initiator is continuously added to the second continuous stirred reaction tank reactor.

The present disclosure also is directed to a coating composition comprising any of the resin compositions disclosed herein, and an accelerator.

The present disclosure also is directed to a coating composition comprising a resin composition comprising a (meth)acrylic polymer comprising at least one pendant silane functional group; and an accelerator.

As stated above, the coating composition may comprise, consist essentially of, or consist of an accelerator. Any accelerator capable of accelerating the curing of the resin composition may be used in the present disclosure. Suitable accelerators for use with the silane-containing polymers include metal-based accelerators and non-metal-based accelerators.

The metal-based accelerators may be metal salts or bases or organometallic species. Examples of suitable metal-based accelerators include but are not limited to tin-based accelerators, zinc-based accelerators, zirconium-based accelerators, bismuth-based accelerators, titanium-based accelerators, potassium-based accelerators, or combinations thereof. Examples of suitable tin-based accelerators include but are not limited to dibutyltin diacetylacetonate, dimethyltin diacetate, dimethyltin bis(acetylacetonate), dibutyltin dilaurate, dibutyltin maleate, dibutyltin phthalate, dibutyltin dioctanoate, dibutyltin bis(2-ethyl-hexanoate), dibutyltin bis(methylmaleate), dibutyltin bis(ethylmaleate), dibutyltin bis(butylmaleate), dibutyltin bis(octylmaleate), dibutyltin bis(tridecylmaleate), dibutyltin bis(benzylmaleate), dibutyltin diacetate, dioctyltin bis(triethoxysilicate), dioctyltin bis(ethylmaleate), dioctyltin bis(octylmaleate), dibutyl tin dimethoxide, dibutyl tin bis(nonylphenoxide), dibutenyl tin oxide, dibutyl tin oxide, reaction product of dibutyltin oxide and silicate compound, reaction product of dibutyltin oxide and phthalic acid ester, dioctyltin dilaurate, dioctyltin oxide, dioctyltin diacetate, or dioctyltin bis(acetylacetonate); tin carboxylate; or combinations thereof. Examples of suitable zinc-based accelerators include but are not limited to the zinc salt of mercaptobenzothiazole (ZMBT); zinc dialkyl dithiocarbamates, such as dimethyl-dithiocarbamate (ZDMC), diethyl-dithiocarbamate (ZDEC), and dibutyl-dithiocarbamate (ZDBC); zinc salts of xanthic acid, zinc bis(2-ethylhexanoate), zinc neodecanoate, zinc octoate, zinc acetylacetonate, zinc oxalate, zinc acetate, or combinations thereof. Examples of suitable zirconium-based accelerators include but are not limited to zirconium tetrakis (acetylacetonate), zirconium carboxylate, zirconium octoate, zirconium ethyl acetylacetonate complex, or combinations thereof. Examples of suitable bismuth salts include but are not limited to bismuth tris(neodecanoate), bismuth tris(2-ethylhexanoate), bismuth oxide, and other bismuth carboxylates, or combinations thereof. Examples of suitable titanium-based accelerators include but are not limited to tetraisopropyl orthotitanate, titanium oxyacetylacetonate, titanium triethanolamine, and titanium ethylacetylacetonate. Examples of suitable potassium-based accelerators include but are not limited to potassium salts of carboxylic acids such as potassium neodecanoate.

Examples of suitable commercial products that may be used include FASCAT 4203 from Arkema; Neostann U220-H available from Kaneka; K-Kat 4205, K-Kat 6212, K-Kat XK-635, K-Kat XK-651, K-Kat 670, K-Kat XK-672 available from King Industries; Perkacit ZDEC and Perkacit ZBEC available from Performance Chemicals; and TIB KAT 218, TIB KAT 223, TIB KAT 616, TIB KAT 720, TIB KAT 725, and TIB Kat K25 available from TIB Chemicals.

Examples of suitable non-metal-based accelerators are amine-based accelerators and acid-based accelerators. Examples of amines that may be useful comprise quaternary amines, tertiary amines, cyclic tertiary amines, secondary amines, cyclic secondary amines, and primary amines. Some examples include trimethylamine, butylamine, tributylamine, octylamine, laurylamine, dibutylamines, monoethanolamines, diethanolamines, triethanolamine, diethylenetriamine, triethylenetetriamine, oleylamines, diethanolamines, triethanolamine, cyclohexylamine, benzylamine, diethylaminopropylamine, xylylenediamine, triethylenediamine, guanidine, dimethylguanidine, tetramethylguanidine, pentamethylguanidine, phenylguanidine, diphenylguanidine, butylbiguanide, 1-o-tolylbiguanide, 1-phenylbiguanide, 1-methyl-3-nitroguanidine, 1,8-bis(tetramethylguanidino)-naphthalene, N,N,N′,N′-tetramethyl-N″-[4-morpholinyl(phenylimino)methyl]guanidine, 2,4,6-tris(dimethylaminomethyl)phenol, 2,2′-dimorpholinodiethylether, morpholine, N-methylmorpholine, 2-ethyl-4-methylimidazole, 1,8-diacabicyclo-(5,4,0)-undecene-7 (DBU), N,N-bis(N,N-dimethyl-2-aminoethyl)methylamine, N,N-dimethylcyclohexylamine, N-methylmorpholine, N-ethylmorpholine, piperidine; piperazine; pyrrolidine, homopiperazine, 1,2-dimethyl-1,4,5,6-tetrahydropyrimidine, 1,4,5,6-tetrahydropyrimidine, 1,8-diazabicyclo[5.4.0]undec-7-ene; 1,5,7-triazabicyclo[4.4.0]dec-5-ene, 7-methyl-1,5,7-triazabicyclo[4.4.0]dec-5-ene, 1,5-diazabicyclo[4.3.0]non-5-ene, 6-(dibutylamino)-1,8-diazabicyclo(5,4,0)undec-7-ene, 1,4-diazabicyclo[2.2.2]octane, 7-azabicyclo[2.2.1]heptane, N, N-dimethylphenylamine, 4,5-dihydro-1H-imidazole, or combinations thereof.

Examples of suitable commercial products that may be used include diethanolamine and triethanolamine T85 available from BASF; and Ancamine K-54, Curezol C17Z, DABCO 33-LV, Polycat DBU, and Vestamin IPD available from Evonik.

The accelerator may be an acid. Examples of suitable acids that may be used comprise sulfonic acid, p-toluene sulfonic acid, n-butylphosphoric acid, methanesulfonic acid, hydroxyethanesulfonic acid, sodium sulfosuccinate, sulfosuccinic acid, hydrochloric acid, nitric acid, formic acid, citric acid, ascorbic acid, acetic acid, triflic acid, fatty acids such as dimer acid, trimer acid, lauric acid, stearic acid, and palmitic acid; trimellitic acid, resorcinol, sebacic acid, suberic acid, glutaric acid, terephthalic acid, 4,4-Bis(4-hydroxyphenyl)valeric acid, diphenolic acid, (poly)(meth)acrylic acid, or the like.

The coating composition may comprise the accelerator in an amount of at least 0.0001% by weight based on the total weight of the coating composition, such as at least 0.001% by weight, such as at least 0.005% by weight, such as at least 0.01% by weight. The coating composition may comprise the accelerator in an amount of no more than 10% by weight based on the total weight of the coating composition, such as no more than 5% by weight, such as no more than 3% by weight such as no more than 2% by weight. The coating composition may comprise the accelerator in an amount of 0.0001% to 10% by weight based on the total weight of the composition, such as 0.001% to 5% by weight, such as 0.005% to 3% by weight, such as 0.01% to 2% by weight.

The Tg of the cured coating composition may be at least −60° C., such as at least −45° C., such as at least −35° C., such as at least −20° C. The Tg of the cured coating composition may be no more than 50° C., such as no more than 40° C., such as no more than 30° C., such as no more than 20° C. The Tg of the cured coating composition may be −60° C. to 50° C., such as −45° C. to 40° C., such as −35° C. to 30° C., such as −20° C. to 20° C.

The cured Tg and crosslink density can be measured by dynamic mechanical analysis. The Tg was reported as the maximum of the tan delta curve. Multiple Tg values were reported when the tan delta curve had more than one significant local maximum. Crosslink density in unites of mmol/cc was calculated based on the equation (G′*1000000*10)/(3*(T+273)*83140), where G′ is the storage modulus of the rubbery plateau region in MPa and T is the temperature in ° C.

Optionally, the coating composition may further comprise, consist essentially of, or consist of a filler. The filler may comprise a pigment mixture. The filler may comprise carbon black, graphite, clay minerals, mineral fibers, cellulose fibers, carbon fibers, glass or polymeric fibers or beads (3M Glass Bubbles K25, S28HS, S38HS, S32 HS, iM16K, and iM30K available from 3M; Expancel 551 DE 40 d42, 461 DET 40 d25, and 920 DET available from Nouryon), carbonates, mica (WG-325, available from Imerys), powdered slate, glass flakes, metal flakes, graphite, metal oxides, ferrite, barytes, wollastonite (NYAD 1250, NYAD M325, and NYAD 400 available from Imerys), perlite, ground natural or synthetic rubber, silica, magnesium sulfate, aluminum hydroxide, alumina powder, aluminum silicate, barium sulfate, and mixtures thereof. Useful aluminum silicates include nepheline syenite (Minex 2, 3, 4, 7, and 10 available from Unimin). Useful clay minerals include talc (Nicron 302, 402, 503, and 674; Arctic Mist; Jetfine 1H; Mistron Monomix; and Vertal 97 available from Imerys), pyrophyllite, kaolin clay (Glomax LL and Hydrite UF 90 available from Imerys and Snobrite available from Unimin), chlorite, montmorillonite, bentonite, vermiculite, or combinations thereof. Useful carbonates include ground or precipitated, untreated or hydrophobically coated such as stearate coated calcium carbonate (#10 white, Atomite, Camel Cal, Drikalite, Duramite, and Winnofil SPT available from Imerys; Omyacarb 3-LU, 8-LU, and UL-FL available from Omya; Ultra Pflex, Ultra Pflex 100, and Albacar HO available from Specialty Minerals), magnesium carbonate, or combinations thereof. Useful silica includes diatomaceous earth (Diafil 575, 525, 540, and 570 available from Imerys), ground quartz (Imsil A-8, A-10, A-15, A-25, A-30, and 1240 available from Unimin), sand, hydrophilic or hydrophobic fumed silica (Aerosil 200, R202, R805, and R972 available from Evonik), or combinations thereof. Useful metal oxides include iron oxide, aluminum oxide, magnesium oxide, titanium dioxide, and combinations thereof.

The coating composition may further comprise one or more plasticizers. Non-limiting examples of suitable plasticizers include adipates, benzoates, dibenzoates, glutarates, isophthalates, phosphates, phthalates, polyesters, polyglycols, fatty ester derivatives, sulfonamides and terephthalates. Suitable examples of benzoates and dibenzoates include diethyleneglycol dibenzoate (Benzoflex 9-88 available from Eastman), 1,4-cyclohexanedimethanol dibenzoate (Benzoflex 352 available from Eastman), isodecyl benzoate (Jayflex MB-10 available from Exxon Mobile), dipropylene dibenzoate (Kalama K-Flex DP available from Emerald Performance Materials), 2-ethylhexyl benzoate (Velate 368 available from Eastman), 2,2,4-trimethyl-1,3-pentanediol dibenzoate, 1,2-bis-benzoyloxy-propane, or combinations thereof. Suitable examples of phthalates include diisononyl phthalate (DINP, Jayflex DINP available from Exxon Mobile), diisodecylphthalate (DIDP, Jayflex DIDP available from Exxon Mobile), phthalic acid dibutyl ester (DBP available from BASF), diethyl phthalate, dioctyl phthalate (DOP, Jayflex DOP available from Exxon Mobile), or combinations thereof. Suitable polyglycols include polyethylene glycol, polypropylene glycol (Arcol polyol PPG-1000, PPG-1025, PPG-2000, PPG-3025, and PPG-4000 available from Covestro), or mixtures thereof. Suitable polyesters and fatty ester derivatives include cyclohexanedicarboxylic acid dinonyl ester (DINCH, Hexamoll DINCH available from BASF), acetyltributyl citrate (ATBC), diisononyl adipate (DNA, Plastomoll DNA available from BASF), bis(2-ethylhexyl) azelate (DOZ, Plastolein 9058 available from BASF), trioctyl trimellitate (TOTM available from Eastman), dioctylterephthalate (DOTP, Eastman 168 plasticizer available from Eastman), epoxidized soybean oil (Vikoflex 7170 available from Arkema), epoxidized linseed oil (Vikoflex 7190 available from Arkema), castor oil, and tung oil.

If present at all, the coating composition may comprise the plasticizer in an amount of at least 0.5% by weight based on the total weight of the coating composition, such as at least 1% by weight, such as at least 2% by weight. The coating composition may comprise the plasticizer in an amount of no more than 30% by weight based on total weight of the coating composition, such as no more than 25% by weight, such as no more than 20% by weight. If present at all, the coating composition may comprise the plasticizer in an amount of 0.5% to 30% by weight based on total weight of the coating composition, such as 1% to 25% by weight, such as 2% to 20% by weight.

If a pigment is present at all, the coating composition may comprise a pigment to binder ratio of at least 0.1:1.0, such as at least 0.2:1.0, such as at least 0.5:1.0, such as at least 1.0:1.0. The coating composition may comprise a pigment to binder ratio of no more than 5.0:1.0, such as no more than 4.0:1.0, such as no more than 3.0:1.0, such as no more than 2.0:1.0. The coating composition may comprise a pigment to binder ratio of 0.1:1.0 to 5.0:1.0, such as 0.2:1.0 to 4.0:1.0, such as 0.5:1.0 to 3.0:1.0, such as 1.0:1.0 to 2.0:1.0.

The binder in the previous paragraph includes the resin binder and, if present, the plasticizer, but does not include reactive diluents. The pigment in the previous paragraph includes anything solid in the composition. Examples include, but are not limited to, fillers, solid colorants, blowing agents, and expandable polymeric microspheres or beads. Examples of solid colorants that may be used include, but are not limited to, carbon black and titanium dioxide. Examples of expandable microspheres or beads that may be used include, but are not limited to, polypropylene microspheres and polyethylene microspheres.

The coating composition also may include a variety of optional ingredients and/or additives that are somewhat dependent on the particular application of the coating composition, such as dyes or colorants, such as red iron pigment, phthalocyanine blue, or combinations thereof, reinforcements, thixotropes, surfactants, extenders, stabilizers, corrosion inhibitors, diluents, blowing agents and antioxidants.

Certain fillers may impart thixotropic properties such as fumed silica, bentonite, and small particle sized calcium carbonates. Additional suitable thixotropes include fatty acid/oil derivatives and associative urethane thickeners such as RM-8 which is commercially available from Dow Chemical Company. Useful thixotropes that may be used include Castor wax, castor oil derivatives, amide waxes, organo clay and combinations thereof. In addition, fibers such as synthetic fibers like Aramid® fiber and Kevlar® fiber, acrylic fibers, and/or engineered cellulose fiber may also be utilized. Commercially available thixotropes useful include Disparlon 6100, 6200, and 6500 available from King Industries; Garamite 1958 available from BYK Company; Bentone SD2; Thixatrol ST, Thixatrol Max, and Thixatrol Plus available from Elementis; and Crayvallac SLX available from Palmer Holland. Thixotropes are generally present in an amount of up to about 20 weight percent.

If present at all, the coating composition may comprise thixotropes in an amount of at least 1% by weight based on total weight of the coating composition, such as at least 2% by weight, such as at least 2.5% by weight. If present at all, the coating composition may comprise thixotropes in an amount of no more than 20% by weight based on total weight of the coating composition, such as no more than 10% by weight, such as no more than 7% by weight. If present at all, the coating composition may comprise thixotropes in an amount of 1% to 20% by weight based on total weight of the coating composition, such as 2% to 10% by weight, such as 2.5% to 7% by weight.

Optional additional ingredients such as blowing agents, expandable polymeric microspheres or beads, such as polypropylene or polyethylene microspheres, surfactants and corrosion inhibitors like barium sulfonate are generally present in an amount of less than about 5% by weight of the total weight of the coating composition, if present at all.

The coating composition optionally may comprise a moisture scavenger. Suitable moisture scavengers include vinyltrimethoxysilane (Silquest A-171 from Momentive), vinyltriethoxysilane (Silquest A-151NT from Momentive), gamma-methacryloxypropyltrimethoxysilane (Silquest A-174NT available from Evonik), other proprietary vinyl silanes (Silquest Y-19557 and Y-15866), molecular sieves, calcium oxide (POLYCAL OS325 available from Mississippi Lime), anhydrous magnesium sulfate, or combinations thereof.

The coating composition also may comprise a solvent. Suitable solvents include ketones such as acetone and methyl ethyl ketone; esters such as ethyl acetate and butyl acetate; hydrocarbons such as pentanes, hexanes, heptanes, and higher molecular weight hydrocarbons and mixtures of isomers thereof such as mineral spirits; aromatics such as benzene, toluene, xylene, 4-chlorobenzotrifluoride; ester alcohols such as 2,2,4-trimethyl-1,3-pentanediol monoisobutyrate; ether alcohols such as diethylene glycol monobutyl ether and 1-butoxy-2-propanol; alcohols such as methanol, ethanol, isopropanol, and higher molecular weight alcohols and mixtures of isomers thereof; and combinations thereof. Commercially available solvents include Kwik Dri 66 (Ashland); Butyl Dioxitol, Shellsol OMS, and Shellsol D60 (Shell Chemicals); Texanol (Eastman); Dowanol PNB (Dow); and Calumet 180-210, Calumet 210-245, and Calumet 6134 (Calumet Specialty Products).

The coating composition also may comprise a solvent. Suitable solvents include acetone, ethyl acetate, methyl ethyl ketone, pentanes, hexanes, heptanes, mineral spirits, benzene, toluene, xylene, 4-chlorobenzotrifluoride, methanol, ethanol, isopropanol, and combinations thereof.

If present at all, the coating composition may comprise solvent in an amount of at least 0.5% by weight based on total weight of the coating composition, such as at least 1% by weight, such as at least 1.5% by weight, such as at least 2% by weight. If present at all, the coating composition may comprise solvent in an amount of no more than 60% by weight based on total weight of the coating composition, such as no more than 40% by weight, such as no more than 30% by weight, such as no more than 20% by weight. If present at all, the coating composition may comprise solvent in an amount of 0.5% by weight to 60% by weight based on total weight of the coating composition, such as 1% by weight to 40% by weight, such as 1.5% by weight to 30% by weight, such as 2% by weight to 20% by weight.

The coating composition may comprise a reactive diluent. Some moisture scavengers may act as reactive diluents and may crosslink with silane residues once both have reacted with water. Some reactive diluents may promote adhesion. Reactive diluents may include inorganic and organic silicon containing molecules. Suitable reactive diluents may include partially hydrolyzed tetraethyl orthosilicate (TEOS, Dynasylan Silbond 40 available from Evonik), silane functional urethanes (Vestanat EP-MF 201, 202, 203, and 204 available from Evonik), nonpolymeric silanes such as dimethoxydimethylsilane (Z-6194 available from Dow Corning), methyltrimethoxysilane (Silquest A-1630A available from Momentive), phenyltrimethoxysilane (Dynasylan 9165 available from Evonik), gamma-aminopropyltrimethoxysilane (Silquest A-1110 available from Momentive), N-beta-(aminoethyl)-gamma-aminopropyltrimethoxysilane (Silquest A-1120 available from Momentive), bis-(gamma-trimethoxysilylpropyl)amine (Silquest A-1170 available from Momentive), (3-glycidyloxypropyl)trimethoxysilane (Silquest A-187 available from Momentive), and beta-(3,4-epoxycyclohexyl)ethyltrimethoxysilane (Silquest A-186 available from Momentive).

If present at all, the coating composition may comprise reactive diluent in an amount of at least 0.5% by weight based on total weight of the coating composition, such as at least 1% by weight, such as at least 1.5% by weight, such as at least 2% by weight. If present in at all, the coating composition may comprise reactive diluent in an amount of no more than 30% by weight based on total weight of the coating composition, such as no more than 25% by weight, such as no more than 20% by weight, such as no more than 15% by weight. If present at all, the coating composition may comprise reactive diluent in an amount of 0.5% by weight to 30% by weight based on total weight of the coating composition, such as 1% by weight to 25% by weight, such as 1.5% by weight to 20% by weight, such as 2% by weight to 15% by weight.

The coating composition optionally may further comprise an antioxidant, a UV absorber, a tackifier, and the like in amounts known to those skilled in the art.

The coating composition optionally may further comprise a polyurethane. The polyurethane may comprise any of those described hereinabove with respect to the resin composition.

If present at all, the coating composition may comprise the polyurethane in an amount of at least 3 percent by weight based on total weight of the coating composition, such as at least 5 percent by weight, such as at least 6 percent by weight, such as at least 10 percent by weight. If present at all, the coating composition may comprise the polyurethane in an amount of no more than 90 percent by weight based on total weight of the coating composition, such as no more than 50 percent by weight, such as no more than 40 percent by weight, such as no more than 30 percent by weight. If present at all, the coating composition may comprise the polyurethan in an amount of 3 percent by weight to 90 percent by weight, such as 10 percent by weight to 90 percent by weight, such as 3 percent by weight to 50 percent by weight based on total weight of the coating composition, such as 5 percent by weight to 40 percent by weight, such as 6 percent by weight to 30 percent by weight.

The viscosity of the uncured coating composition at a shear rate of 100 s⁻¹ (measured on an Anton Paar MCR 92 rheometer at 25° C. using a 15 mm diameter parallel plate and a 0.5 mm gap) may be at least 100 mPa·s, such as at least 500 mPa·s, such as at least 1,000 mPa·s. The viscosity of the uncured coating composition at a shear rate of 100 s⁻¹ may be no more than 10,000,000 mPa·s, such as no more than 5,000,000 mPa·s, such as no more than 1,000,000 mPa·s. The viscosity of the uncured coating composition at a shear rate of 100 s⁻¹ (measured on an Anton Paar MCR 92 rheometer at 25° C. using a 15 mm diameter parallel plate and a 0.5 mm gap) may be 100 mPa·s to 10,000,000 mPa·s, such as 500 mPa·s to 5,000,000 mPa·s, such as 1,000 mPa·s to 1,000,000 mPa·s.

The viscosity of the uncured coating composition at a shear rate of 0.01 s⁻¹ (measured on an Anton Paar MCR 92 rheometer at 25° C. using a 15 mm diameter parallel plate and a 0.5 mm gap) may be at least 1,000 mPa·s, such as at least 5,000 mPa·s, such as at least 10,000 mPa·s. The viscosity of the uncured coating composition at a shear rate of 0.01 s⁻¹ may be no more than 1,000,000,000 mPa·s, such as no more than 500,000,000 mPa·s, such as no more than 100,000,000 mPa·s. The viscosity of the uncured coating composition at a shear rate of 0.01 s⁻¹ (measured on an Anton Paar MCR 92 rheometer at 25° C. using a 15 mm diameter parallel plate and a 0.5 mm gap) may be 1,000 mPa·s to 1,000,000,000 mPa·s, such as 5,000 mPa·s to 500,000,000 mPa·s, such as 10,000 mPa·s to 100,000,000 mPa·s.

The crosslink density of the cured coating composition may be at least 0.1 mmol/cc, such as at least 0.3 mmol/cc, such as at least 0.5 mmol/cc. The crosslink density of the coating composition may be no more than 7.0 mmol/cc, such as no more than 5.0 mmol/cc, such as no more than 3.0 mmol/cc. The crosslink density of the coating composition may be 0.1 mmol/cc to 7.0 mmol/cc, such as 0.3 mmol/cc to 5.0 mmol/cc, such as 0.5 mmol/cc to 3.0 mmol/cc.

The compositions disclosed herein may be in the form of one-component compositions.

The components of the one-component composition may be combined and packaged in a moisture-sealed container to substantially prevent curing. The composition is stable under conditions substantially free of moisture and at ambient temperatures. The components of the one-component composition may be combined and frozen and stored (“pre-mixed frozen” or “PMF”) and may be thawed and cured by exposure to moisture or water and optionally also by external factors, such as temperature. In examples, the PMF may be stored at temperatures between and including −100° C. and −25° C., such as −100° C. to −15° C., to retard hardening, such as at a minimum of −75° C., such as at a maximum of −40° C.

When the moisture sealed container is unsealed and the composition applied to a substrate, the composition may be exposed to moisture which promotes curing of the composition to form a coating, such as a sealant or an adhesive, as described in more detail below.

The compositions disclosed herein may be multi-component compositions, such as 2K compositions, 3K compositions, or higher, comprising, or consisting essentially of, or consisting of, a first component comprising, consisting essentially of, or consisting of, one of the resin compositions disclosed herein; a second component comprising, or consisting essentially of, or consisting of, a moisture or curing agent and/or an accelerator; and optionally any of the optional ingredients described hereinabove. The optional ingredients may be present in the first, second and/or third components. The multiple components may be mixed together immediately prior to use.

The compositions disclosed herein may be multi-component compositions, such as 2K compositions, 3K compositions, or higher, comprising, or consisting essentially of, or consisting of, a first component comprising, consisting essentially of, or consisting of, a resin composition comprising a (meth)acrylic polymer comprising at least one pendant silane functional group; a second component comprising, or consisting essentially of, or consisting of, a moisture or curing agent and/or an accelerator; and optionally any of the optional ingredients described hereinabove. The optional ingredients may be present in the first, second and/or third components. The multiple components may be mixed together immediately prior to use.

It has been surprisingly discovered that adhesives of the present disclosure comprising the (meth)acrylic polymer taught herein provide superior tunability in regard to Tg and crosslink density over polyether-based adhesives. It has also been surprisingly discovered that adhesives of the present disclosure comprising (meth)acrylic polymers taught herein may achieve higher pigment loading than polyether adhesives. Finally, it has been surprisingly discovered that coating compositions of the present disclosure provide an increase in compression shear strength of a joint bonded with the coating composition. It has been surprisingly discovered that blending a silane functional polyurethane resin and a silane functional acrylic resin increases the strength of the system relative to individual resin systems and this synergistic improvement was not observed between silane functional polyethers and silane functional acrylics.

The present disclosure is also directed to an article comprising: a first substrate comprising a surface at least partially coated with a layer formed from a coating composition comprising one of the resin compositions disclosed herein in an at least partially cured state.

The present disclosure is also directed to an article comprising: a first substrate comprising a surface at least partially coated with a layer formed from one of the coating compositions disclosed herein in an at least partially cured state.

The coatings may be cured at greater than 4° C., such as at greater than 7° C., such as at ambient temperature, or higher than ambient temperature. Suitable substrate materials include, but are not limited to, materials such as natural materials such as wood, metals or metal alloys, polymeric materials such as hard plastics, or composite materials wherein each of the first and second substrate material may be independently selected from these materials. The adhesives of the present disclosure are particularly suitable for use in various construction applications in which substrates are bonded together with the adhesive and also are connected by fasteners such as screws, nails, or the like.

The present disclosure is also directed to a method of forming a coating on a substrate comprising, consisting essentially of, or consisting of, applying a coating composition comprising one of the resin compositions disclosed herein onto at least a portion of a surface of the substrate.

The present disclosure is also directed to a method of forming a coating on a substrate comprising, consisting essentially of, or consisting of, applying one of the coating compositions disclosed herein onto at least a portion of a surface of the substrate.

The present disclosure is also directed to a method of forming a bond between two substrates comprising, consisting essentially of, or consisting of, applying a coating composition comprising one of the resin compositions disclosed herein to a first substrate; and contacting a second substrate to the coating composition such that the coating composition is located between the first substrate and the second substrate.

The present disclosure is also directed to a method of forming a bond between two substrates comprising, consisting essentially of, or consisting of, applying one of the coating compositions disclosed herein to a first substrate; and contacting a second substrate to the coating composition such that the coating composition is located between the first substrate and the second substrate.

The coating composition can be applied to the surface of a substrate in any number of different ways, non-limiting examples of which include brushes, blades, rollers, films, pellets, trowels, spatulas, dips, spray guns, applicator guns, caulking guns, and pneumatic guns to form a coating on at least a portion of the substrate surface. The coating composition may be applied to cleaned or uncleaned (i.e., including oil or oiled) substrate surfaces.

After application to the substrate(s), the coating composition may be cured by exposure to moisture or water, and optionally may be further cured by baking and/or curing at elevated temperature, such as 100° C. or below, such as 90° C. or below, such as 80° C. or below, such as 70° C. or below, but greater than ambient, such as greater than 40° C., such as greater than 50° C., and for any desired time period (e.g., from 5 minutes to 1 hour) sufficient to at least partially cure the coating composition on the substrate(s). The coating composition may be cured by baking and/or curing at elevated temperature such as at 40° C. to 1000° C., such as 40° C. to 90° C., such as 50° C. to 80° C. Alternatively, the coating composition of the present disclosure may cure at ambient conditions or below ambient conditions, such as 0° C., such as −7° C.

The present disclosure is also directed to a method for forming a bond between two substrates for a wide variety of potential applications in which the bond between the substrates provides particular mechanical properties related to compression shear strength. The method may comprise, or consist essentially of, or consist of, applying the coating composition described above to a first substrate; contacting a second substrate to the coating composition such that the coating composition is located between the first substrate and the second substrate; and curing the coating composition under ambient conditions or by exposure to moisture or water, and optionally may be further cured by baking and/or curing at elevated temperature, such as 100° C. or below, such as 90° C. or below, such as 80° C. or below, such as 70° C. or below, but greater than ambient, such as greater than 40° C., such as greater than 50° C., and for any desired time period (e.g., from 5 minutes to 1 hour) sufficient to at least partially cure the coating composition on the substrate(s). The coating composition may be cured by baking and/or curing at elevated temperature such as at 40° C. to 1000° C., such as 40° C. to 90° C., such as 50° C. to 80° C. Alternatively, the coating composition of the present disclosure may cure at ambient conditions or below ambient conditions, such as 0° C., such as −7° C. For example, the coating composition may be applied to either one or both of the substrate materials being bonded to form an adhesive bond therebetween and the substrates may be aligned and pressure and/or spacers may be added to control bond thickness. The coating composition may be applied to cleaned or uncleaned (i.e., including oily or oiled) substrate surfaces.

The coating composition described above may be applied alone or as part of an adhesive system that can be deposited in a number of different ways onto a number of different substrates. The adhesive system may comprise a number of the same or different adhesive layers and may further comprise other coating compositions such as pretreatment compositions and the like. An adhesive layer is typically formed when an adhesive composition that is deposited onto the substrate is at least partially dried by methods known to those of ordinary skill in the art (e.g., by exposure to ambient conditions or heating).

As stated above, the coating composition of the present disclosure also may form a coating on a substrate or a substrate surface. The coating composition may be applied to substrate surfaces, including, by way of non-limiting example, architectural parts, construction parts, electronic parts, furniture, portable devices, telecommunications devices, athletic equipment, apparel, toys, a vehicle body or components of an automobile frame or an airplane. Architectural parts include but are not limited to pipes, such as plumbing pipes, portable water pipes, and drain pipes; conduit, such as electrical conduit; electrical wiring; lumber and composites, such as composite decking, wood decking, plastic decking, fencing, wall paneling, plastic sheeting, rubber sheeting, and pressure treated wood; roofing materials, such as metal roofing, asphalt shingles, slate shingles, terra cotta shingles, roof flashing, gutters, and vents; cabinetry; flooring, such as composite flooring, laminate flooring, vinyl flooring, nylon flooring, carpet, gym flooring, garage flooring, and sealed stone or ceramic flooring; siding, such as vinyl siding, aluminum siding, composite siding, veneer siding, and cementitious siding; insulation, such as fiberglass insulation and foam insulation; ceiling tiles; trim, such as window trim, door trim, moulding; fixtures, such as lighting fixtures, tubs, sinks, and showers; underlayments; leak barriers; and waterproofing membranes. The sealant or adhesive formed by the coating composition of the present disclosure provides sufficient tensile strength and tensile elongation. The coating composition may be applied to cleaned or uncleaned (i.e., including oily or oiled) substrate surfaces. It may also be applied to a substrate that has been pretreated, coated with an electrodepositable coating, and/or coated with additional layers such as a primer, basecoat, or topcoat. The coating composition may dry or cure at ambient conditions once applied to a substrate or substrates coated with coating compositions may optionally subsequently be baked in an oven to cure the coating composition.

According to the present disclosure, a coating is provided which, in an at least partially dried or cured state, surprisingly may demonstrate at least one of the following:
(a) a Tg of the cured coating (measured by dynamic mechanical analysis) may be at least −60° C., such as at least −450° C., such as at least −35° C., such as at least −20° C. The Tg of the cured coating may be no more than 50° C., such as no more than 40° C., such as no more than 30° C., such as no more than 20° C. The Tg of the cured coating may be −60° C. to 50° C., such as −45° C. to 40° C., such as −35° C. to 30° C., such as −20° C. to 20° C.;
(b) a compression shear strength of at least 50 psi (measured according to ASTM D-905 using an Instron 5667 or 5669 machine in compression mode with a rate of 0.2 inches per minute), such as at least 80 psi, such as at least 110 psi, such as at least 150 psi, such as at least 200 psi, such as at least 250 psi;
(c) a tensile strength of at least 0.5 MPa (measured according to ASTM D412 using dumbbell die D geometry on an Instron 5667 or 5569 machine in tensile mode with a pull rate of 25.4 mm per minute and a clamp distance of 70 mm), such as at least 1 MPa, such as at least 2 MPa;
(d) a tensile elongation of at least 2% (measured according to ASTM D412 using dumbbell die D geometry on an Instron 5667 or 5569 machine in tensile mode with a pull rate of 25.4 mm per minute and a clamp distance of 70 mm), such as at least 4%, such as at least 8%; and/or
(e) a Young's modulus of 1 to 400 MPa (measured according to ASTM D412 using dumbbell die D geometry on an Instron 5667 or 5569 machine in tensile mode with a pull rate of 25.4 mm per minute and a clamp distance of 70 mm), such as 2 to 200 MPa, such as 4 to 100 MPa.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

TABLE 1
Raw materials used in the examples.

| Abbreviation | Description |
|---|---|
| #10 white | Medium particle size (12-14 micron) ground calcium |
| | carbonate available from Imerys |
| αMSD | α-Methyl styrene dimer (2,4-diphenyl-4-methyl-1- |
| | pentene) available from Mitsui Chemicals |
| Aerosil R 805 | Hydrophobic fumed silica available from Evonik |
| BA | n-Butyl acrylate available from BASF |
| Butyl | 2-Butoxyethanol available from Dow |
| Cellosolve | |
| DBTDL | Dibutyltin dilaurate |
| Dowanol PM | 1-Methoxy-2-propanol available from Dow |
| Dowanol PM | Propylene glycol methyl ether acetate available from |
| Acetate | Dow |
| Dynasylan | N-Butylaminopropyltrimethoxysilane available from |
| A1189 | Evonik |
| EHA | 2-Ethylhexyl Acrylate available from BASF |
| Glomax LL | Calcined kaolin clay available from Imerys |
| HEA | 2-hydroxyethyl acrylate available from BASF |
| IPDI | Isophorane Diisocyanate monomer |
| K-Kat XK-635 | Zinc-based accelerator available from King Industries |
| K-Kat XK-651 | Bismuth-based accelerator available from King |
| | Industries |
| Luperox 270 | tert-butyl peroxy-3,5,5-trimethylhexanoate available |
| | from Arkema |
| Luperox 575 | t-Amylperoxy-2-ethyl hexanoate available from |
| | Arkema |
| Luperox DTA | Di-t-amyl peroxide available from Arkema |
| MA 480 | Trimethoxysilyl acryl modified silane functional |
| | polyether available from Kaneka |
| MMA | Methyl methacrylate available from BASF |
| Neostann | Dibutyltin diacetylacetonate available from Kaneka |
| U220-H | |
| SAX 350 | Methyldimethoxysilane terminated polyether available |
| | from Kaneka |
| SAX 400 | Methyldimethoxysilane terminated polyether available |
| | from Kaneka |
| Silquest | N-(beta-aminoethyl) gamma-aminopropyltrimethoxy- |
| A-1120 | silane available from Momentive |
| Silquest A-171 | Vinyltrimethoxysilane available from Momentive |
| Silquest A-174NT | 3-(Trimethoxysilyl)propyl methacrylate available |
| | from Momentive |
| SPUR + | Silylated polyurethane resin available from |
| 1015LM | Momentive |
| STP-E 10 | Dimethoxy(methyl)silylmethylcarbamate-terminated |
| | polyether available from Wacker |
| STP-E 30 | Dimethoxy(methyl)silylmethylcarbamate-terminated |
| | polyether available from Wacker |
| Styrene | Styrene monomer available from Solvay |
| Tegopac seal 100 | Ethoxysilane modified polymer available from Evonik |
| Terethane 650 | Poly(tetramethylene ether) glycol available from |
| | Invista |
| VA | Vinyl acetate monomer available from Dow |

### Resin Examples

Resin compositions described below for Polymers A-C, G, M and N were prepared according to the following procedure: Charge #1 was added to a 3-liter, 4-necked flask equipped with a motor driven stainless stir blade, water-cooled condenser and a heating mantle with a thermometer connected through a temperature feedback control device. The contents of the flask were heated to reflux (120° C. for Dowanol PM and 140° C. for butanol) under a nitrogen blanket. Charge #2 was added into the flask through an addition funnel for over 180 minutes. At the same time, Charge #3 was added into the flask through a separate addition funnel for over 210 minutes. After the addition of Charge #3 was complete, the reaction was held at 120° C. for 30 minutes. The mixture was then cooled down to 100° C. and vacuum was applied to the system to remove all the solvent. After that, Charge #4 was added as a moisture scavenger and the finished resin was then cooled down and poured into a collection container. Polymer properties were quantified as follows: Solids were determined as the mass loss following incubation in an oven at 110° C. for 1 h. The total free monomer was determined using gas chromatography except where noted. Mn and Mw were determined using GPC. Tg was calculated using the Fox Equation. Brookfield viscosity was measured at room temperature with the settings listed in Table 2.

The resin composition described below for Polymer O was prepared according to the following procedure: Charge #1 was added to a 3-liter, 4-necked flask equipped with a motor driven stainless stir blade, water-cooled condenser and a heating mantle with a thermometer connected through a temperature feedback control device. The contents of the flask were heated to 55° C. under a nitrogen blanket. Charge #2 was added into the flask through an addition funnel at a rate such that the resulting exotherm never exceed 70° C., or approximately 2 hours. After the feed was complete, the contents were slowly heated to 90° C. and allowed to stir for 2 hours. The finished resin was then cooled and poured into a collection container.

The resin composition described below for Polymer P was prepared according to the following procedure: Charge #1 was added to a 3-liter, 4-necked flask equipped with a motor driven stainless stir blade, water-cooled condenser and a heating mantle with a thermometer connected through a temperature feedback control device. The contents of the flask were heated to 120° C. under a nitrogen blanket. Charge #2 was added into the flask through an addition funnel for over 180 minutes. At the same time, Charge #3 was added into the flask through a separate addition funnel for over 210 minutes. After the addition of Charge #3 was complete, the reaction was held at 120° C. for 30 minutes. After that, Charge #4 was added as a moisture scavenger and the finished resin was then cooled and poured into a collection container.

The resin composition described below for Polymer Q was prepared according to the following procedure: Charge #1 was added to a 250-milliliter, 4-necked flask equipped with a motor driven stainless stir blade, water-cooled condenser and a heating mantle with a thermometer connected through a temperature feedback control device. The contents of the flask were heated to 75° C. under a nitrogen blanket. Charge #2 was added dropwise over the course of 5 minutes. Charge #3 was then added slowly over the course of five minutes, at which point the temperature was increased to 100° C. The reaction was held at this temperature for 4 hours, at which point Charge #4 was added. The finished resin was then cooled and poured into a collection container.

The Mn and Mw values were determined by using Gel Permeation Chromatography using Waters 2695 separation module with a Waters 2140 differential refractometer (RI detector) and polystyrene standards. The polydispersity index, PDI, is the ratio of Mw to Mn. Tetrahydrofuran (THF) was used as the eluent at a flow rate of 1 ml min⁻¹, and two PL Gel Mixed C columns were used for separation.

TABLE 2
Synthesis examples of silane acrylic resins.

| Polymer | A | B | C | G | H | M |
|---|---|---|---|---|---|---|
| Charge #1 | | | | | | |
| Butyl | | | | 300 | 300 | 300 |
| Cellosolve | | | | | | |
| Dowanol | 560 | 560 | 560 | | | |
| PM | | | | | | |
| Dowanol | | | | | | |
| PM | | | | | | |
| Acetate | | | | | | |
| IPDI | | | | | | |
| DBTDL | | | | | | |
| Polymer O | | | | | | |
| Charge #2 | | | | | | |
| Dynasylan | | | | | | |
| A1189 | | | | | | |
| EHA | 100 | 5 | 100 | | | |
| Styrene | 50 | — | — | | | |
| Silquest | 300 | 250 | 20 | 480.0 | 400.0 | 48.0 |
| A-174NT | | | | | | |
| BA | 550 | 745 | 700 | 1008.0 | 1000.0 | 944.0 |
| VA | | | | 80.0 | 168.0 | 576.0 |
| MMA | | | | | | |
| HEA | | | | | | |
| αMSD | | | | 32.0 | 32.0 | 32.0 |
| Terathane | | | | | | |
| 650 | | | | | | |
| Charge #3 | | | | | | |
| Luperox | 30 | 30 | 30 | | | |
| 575 | | | | | | |
| Luperox | | | | | | |
| 270 | | | | | | |
| Luperox | | | | 48.0 | 48.0 | 48.0 |
| DTA | | | | | | |
| Polymer P | | | | | | |
| Dowanol | 120 | 120 | 120 | | | |
| PM | | | | | | |
| Dowanol | | | | | | |
| PM | | | | | | |
| Acetate | | | | | | |
| Butyl | | | | 112.0 | 112.0 | 112.0 |
| Cellosolve | | | | | | |
| Charge #4 | | | | | | |
| Silquest | 9.2 | 9.8 | 10 | 15.0 | 15.0 | 15.0 |
| A-171 | | | | | | |
| Butyl | | | | | | |
| Cellosolve | | | | | | |
| Properties | | | | | | |
| Theoretical | 818.2 | 969.2 | 1191.6 | | | |
| silane eq. | | | | | | |
| wt (g/eq) | | | | | | |
| Solids (%) | 98.37 | 98.67 | 98.48 | 98.48 | 99.26 | 98.59 |
| Total free | 0.11 | 0.15 | 0.15 | 0.06** | 0.05** | 0.04** |
| monomer | | | | | | |
| (weight %) | | | | | | |
| Brookfield | 53,400 | 12,400 | 9,040 | 7,200 | 34,720 | 433,000 |
| viscosity | | | | | | |
| (cps) | | | | | | |
| Brookfield | #6, 10 | #6, 50 | #6, 50 | #6, 60 | #7, 50 | #7, 5 |
| settings | rpm | rpm | rpm | rpm | rpm | rpm |
| (Spindle #, | | | | | | |
| rpm) | | | | | | |
| Mn | 4,403 | 3,037 | 2,723 | 2,232 | 2,778 | 2,617 |
| (g/mol) | | | | | | |
| Mw | 16,909 | 9,757 | 6,508 | 8,499 | 13,053 | 7,581 |
| (g/mol) | | | | | | |
| PDI | 3.8 | 3.2 | 2.4 | 3.8 | 4.7 | 2.9 |
| Calculated | −20 | −20 | −20 | −25 | −25 | −25 |
| Tg (° C.) | | | | | | |
| NCO Eq. | | | | | | |
| Wt (g/mol) | | | | | | |
| Theor. OH | | | | | | |
| Eq. Wt. | | | | | | |
| (g/mol) | | | | | | |

| Polymer | N | O | P | Q |
|---|---|---|---|---|
| Charge #1 | | | | |
| Butyl | 300 | | | |
| Cellosolve | | | | |
| Dowanol | | | | 20.00 |
| PM | | | | |
| Dowanol | | | 150.0 | |
| PM | | | | |
| Acetate | | | | |
| IPDI | | 250.0 | | |
| DBTDL | | 0.0391 | | |
| Polymer O | | | | 30.52 |
| Charge #2 | | | | |
| Dynasylan | | | | 6.695 |
| A1189 | | | | |
| EHA | | | | |
| Styrene | | | | |
| Silquest | 16.0 | | 100.0 | |
| A-174NT | | | | |
| BA | 944.0 | | 480.0 | |
| VA | 608.0 | | | |
| MMA | | | 360.0 | |
| HEA | | | 40.0 | |
| αMSD | 32.0 | | 20.0 | |
| Terathane | | 351.9 | | |
| 650 | | | | |
| Charge #3 | | | | |
| Luperox | | | | |
| 575 | | | | |
| Luperox | | | 5.0 | |
| 270 | | | | |
| Luperox | 48.0 | | | |
| DTA | | | | |
| Polymer P | | | | 100.00 |
| Dowanol | | | | |
| PM | | | | |
| Dowanol | | | 100.0 | |
| PM | | | | |
| Acetate | | | | |
| Butyl | 112.0 | | | |
| Cellosolve | | | | |
| Charge #4 | | | | |
| Silquest | 15.0 | | 12.5 | |
| A-171 | | | | |
| Butyl | | | | 10.00 |
| Cellosolve | | | | |
| Properties | | | | |
| Theoretical | | | | |
| silane eq. | | | | |
| wt (g/eq) | | | | |
| Solids (%) | 98.33 | 97.0 | 78.7 | 66.0 |
| Total free | 0.05** | ND* | 0.22* | ND* |
| monomer | | | | |
| (weight %) | | | | |
| Brookfield | 592,000 | 33,450 | 312,000 | 27,500 |
| viscosity | | | | |
| (cps) | | | | |
| Brookfield | #7, 4 | #6, 20 | #7, 10 | #6, 50 |
| settings | rpm | rpm | rpm | rpm |
| (Spindle #, | | | | |
| rpm) | | | | |
| Mn | 2,201 | 1,868 | 4,196 | 3,655 |
| (g/mol) | | | | |
| Mw | 8,184 | 3,230 | 54,588 | 485,945 |
| (g/mol) | | | | |
| PDI | 3.7 | 1.7 | 13.1 | 132 |
| Calculated | −25 | ND | −1.6 | ND |
| Tg (° C.) | | | | |
| NCO Eq. | | 536.6 | | |
| Wt (g/mol) | | | | |
| Theor. OH | | | 3207 | |
| Eq. Wt. | | | | |
| (g/mol) | | | | |

Raw material quantities are measured in parts by weight.
*DMF GPC, due to poor solubility in THF
**Includes only free Silquest A-174NT. Free monomer concentrations of Ba, VA, and αMSD monomers were measured by high performance liquid chromatography (HPLC) instead of gas chromatography and all were below the detection limit of 0.01%

### Adhesive Compositions

Adhesive compositions described below were prepared according to the following procedure with all non-manual mixing performed using a Speedmixer DAC 600.1 FVZ (commercially available from FlackTek, Inc.). The components included under “Silane resins” and “Plasticizers” were combined and mixed for 20 seconds at 2,350 revolutions per minutes (“rpm”). The ingredients listed as “Fillers” were then added and mixed for 10 seconds at 1,250 rpm; 10 seconds at 1,500 rpm; and then 40 seconds at 1,800 rpm. The ingredients listed as “thickeners” were then added and mixed for 150 seconds at 2,350 rpm. The mixture was flushed with nitrogen and allowed to cool to <110° F. before adding the “Additives and accelerators.” Additives and accelerators were added in the order shown mixing manually and then for 20 s at 2,350 rpm after each addition. The mixtures were stored in ¼ pint lined metal paint cans under a nitrogen atmosphere.

All testing was performed under ambient conditions unless otherwise noted.

Adhesive strength was measured by compression shear according to ASTM D-905 except as noted. Shear substrates were made from select pine cut to 1 inch×1¼ inch×¾ inch dimension with the wood grain parallel to the 1¼ inch dimension. Adhesive was applied to one of the 1 inch×1¼ inch faces of the coupon. A second coupon was placed on top of the adhesive with an offset of ¼ inch on the 1-inch side. Samples were pressed with 75-80 pounds of force for 5 seconds with a Rimac spring tester (D1675 from Rinck-McIlwaine Inc.). Excess adhesive was removed with a spatula. Five replicates for each adhesive were prepared. Samples were allowed to cure under ambient conditions for 7 days. Compression was tested on an Instron model 5567 or 5569 using a wood shear fixture model S1-11857-2 under ambient conditions with a rate of 0.2 in/min under compressive extension. Shear strength is reported as the average maximum compressive load of five replicate samples.

Adhesive rheology was measured on an Anton Paar MCR 92 rheometer using a 15 mm diameter parallel plate (PP15 model #9899) with a 0.5 mm gap. The lower plate temperature was set at 25° C. Viscosity was measured with an increasing shear rate from 0.01 s⁻¹ to 100 s⁻¹ with 100 s to 1 s intervals, both with a logarithmic ramp. Rheology was measured 1 day after the adhesives were formulated except as noted.

Adhesive tensile properties including maximum load, maximum elongation, Young's modulus, and toughness were measured according to ASTM D-412 except as noted. A free film of adhesive was obtained by drawing down a liquid sample approximately 10 cm×15 cm×0.15 cm on a polyethylene or Teflon release liner and allowed to cure fully. Test specimens were die cut from the film using an ASTM D-412 dumbbell die D geometry. The actual thickness of each specimen was measured with a caliper before testing. Dumbbell samples were tested on an Instron model 5567 or 5569 with a pull rate of 25.4 mm/min and a clamp distance of 70 mm. Strain was calculated based on the distance the clamps travelled. Raw data were plotted in a stress-strain curve. The maximum load was reported as the maximum stress of the stress-strain curve. Maximum elongation was reported as the strain at break. The Young's modulus was measured as the linear region of the initial stress-strain curve. Toughness was the integrated area under the stress-strain curve from zero strain to the strain at break.

Shore A was measured with a Rex Gauge Type A durometer according to ASTM D-2240 on a fully cured adhesive sample approximately 3 mm thick. Adhesive density was measured on the uncured (liquid) adhesive using a pycnometer. The pycnometer was filled to capacity, a known volume, and the mass measured.

Adhesive Tg and crosslink density were measured by dynamic mechanical analysis on a TA Instruments Q800 in tensile multi-frequency-strain mode on free films of cured adhesives. The strain was 0.10%; the force track was 125%; the preload force was 0.01 N; the clamping force was 20 cNm; and the frequency was 1 Hz. The temperature ranged from −100° C. to +150° C. with a ramp rate of 3° C./min. The Tg was reported as the maximum of the tan delta curve. Multiple Tg values were reported when the tan delta curve had more than one significant local maximum. Crosslink density was calculated based on the equation (G′ *1000000*10)/(3*(T+273)*83140), where G′ is the storage modulus of the rubbery plateau region in MPa and T is the temperature in ° C.

TABLE 3
Comparative examples using commercially available silane resins.

| Example # | Comp. 1 | Comp. 2 | Comp. 3 | Comp. 4 | Comp. 5 | Comp. 6 | Comp. 7 |
|---|---|---|---|---|---|---|---|
| Silane resins | | | | | | | |
| SAX 400 | 40.0 | — | — | — | — | — | — |
| MA 480 | — | 40.0 | — | — | — | — | — |
| STP-E 10 | — | — | 40.0 | — | — | — | — |
| SPUR + | — | — | — | 40.0 | — | — | — |
| 1015LM | | | | | | | |
| Tegopac seal | — | — | — | — | 40.0 | — | — |
| 100 | | | | | | | |
| SAX 350 | — | — | — | — | — | 40.0 | — |
| STP-E 30 | — | — | — | — | — | — | 40.0 |
| Silquest A- | 0.9 | 0.9 | 0.9 | 0.9 | 0.9 | 0.9 | 0.9 |
| 171 | | | | | | | |
| Fillers | | | | | | | |
| #10 white | 53.0 | 53.0 | 53.0 | 53.0 | 53.0 | 53.0 | 53.0 |
| Thickeners | | | | | | | |
| Aerosil R | 3.0 | 3.0 | 3.0 | 3.0 | 3.0 | 3.0 | 3.0 |
| 805 | | | | | | | |
| Additives and accelerators | | | | | | | |
| Silquest A- | 0.9 | 0.9 | 0.9 | 0.9 | 0.9 | 0.9 | 0.9 |
| 171 | | | | | | | |
| Silquest A- | 2.0 | 2.0 | 2.0 | 2.0 | 2.0 | 2.0 | 2.0 |
| 1120 | | | | | | | |
| Neostann | 0.2 | 0.2 | 0.2 | 0.2 | 0.2 | 0.2 | 0.2 |
| U220-H | | | | | | | |
| Performance | | | | | | | |
| Compression | 821 ± 64 | 1314 ± 144 | 587 ± 58 | 737 ± 96 | 242 ± 46 | 448 ± 47 | 302 ± 90 |
| shear (psi) | | | | | | | |
| Viscosity | 8.4E+06 | 3.6E+06 | 1.9E+05 | 5.2E+06 | 9.1E+06 | 1.1E+07 | 6.3E+05 |
| (mPa · s) at | | | | | | | |
| 0.01 s⁻¹ shear | | | | | | | |
| rate | | | | | | | |
| Viscosity | 8.0E+04 | 2.4E+05 | 5.1E+04 | 1.6E+05 | 2.0E+05 | 3.5E+04 | 6.9E+04 |
| (mPa · s) at | | | | | | | |
| 100 s⁻¹ shear | | | | | | | |
| rate | | | | | | | |
| Maximum | 2.5 | 5.1 | 2.5 | 2.6 | 1.1 | 2.4 | 2.2 |
| load (MPa) | | | | | | | |
| Maximum | 45.1% | 22.2% | 36.1% | 55.1% | 41.2% | 53.6% | 35.6% |
| elongation | | | | | | | |
| (%) | | | | | | | |
| Young's | 13 | 28 | 13 | 9 | 2 | 7 | 10 |
| modulus | | | | | | | |
| (MPa) | | | | | | | |
| Toughness | 0.73 | 0.64 | 0.57 | 0.83 | 0.22 | 0.73 | 0.49 |
| (MPa) | | | | | | | |
| Shore A | 77 | 82 | 77 | 74 | 69 | 74 | 68 |
| hardness (7- | | | | | | | |
| day cure) | | | | | | | |
| Density | 12.6 | 12.9 | 12.8 | 12.5 | 12.2 | 12.4 | 12.3 |
| (lbs/gal) | | | | | | | |

Raw material quantities are measured in weight %.

TABLE 4
Examples of adhesive prepared with acrylic silane resin.
All raw material quantities are measured in weight %.

| Example # | Ex. 1 | Ex. 2 | Ex. 3 |
|---|---|---|---|
| Silane resins | | | |
| Polymer A | 40.0 | — | — |
| Polymer B | — | 40.0 | — |
| Polymer C | — | — | 40.0 |
| Silquest A-171 | 0.9 | 0.9 | 0.9 |
| Fillers | | | |
| #10 white | 53.0 | 53.0 | 53.0 |
| Thickeners | | | |
| Aerosil R 805 | 3.0 | 3.0 | 3.0 |
| Additives and accelerators | | | |
| Silquest A-171 | 0.9 | 0.9 | 0.9 |
| Silquest A-1120 | 2.0 | 2.0 | 2.0 |
| Neostann U220-H | 0.2 | 0.2 | 0.2 |
| Performance | | | |
| Compression shear (psi) | 853 ± 141 | 479 ± 117 | 300 ± 140 |
| Viscosity (mPa · s) at 0.01 | 2.7E+06 | 1.4E+06 | 8.3E+05 |
| s⁻¹ shear rate | | | |
| Viscosity (mPa · s) at 100 s⁻¹ | 1.8E+05 | 4.7E+04 | 3.3E+04 |
| shear rate | | | |
| Maximum load (MPa) | ND | ND | ND |
| Maximum elongation (%) | | | |
| Young's modulus (MPa) | | | |
| Toughness (MPa) | | | |
| Shore A hardness (7-day | 88 | 89 | 94 |
| cure) | | | |
| Density (lbs/gal) | 13.0 | 13.1 | 13.1 |

ND = not determined.

The data in Table 4 show that the silane containing acrylic resins can achieve similar shear strength and viscosity as adhesives formulated with commercial resins.

TABLE 5
Examples of adhesives prepared blending silane functional
acrylic and silane functional polyether resins.

| Example # | Ex. 7 | Ex. 8 | Ex. 9 |
|---|---|---|---|
| Silane resins | | | |
| Polymer B | 36.0 | 24.0 | 16.0 |
| Polymer H | | | |
| Kaneka SAX 400 | 4.0 | 16.0 | 24.0 |
| Silquest A-171 | 0.9 | 0.9 | 0.9 |
| Fillers | | | |
| #10 white | 53.0 | 53.0 | 53.0 |
| Thickeners | | | |
| Aerosil R 805 | 3.0 | 3.0 | 3.0 |
| Additives and accelerators | | | |
| Silquest A-171 | 0.90 | 0.90 | 0.90 |
| Silquest A-1120 | 2.00 | 2.00 | 2.00 |
| Neostann U220-H | 0.20 | 0.20 | 0.20 |
| Performance | | | |
| Compression shear (psi) | 417 ± 142 | 127 ± 27 | 89 ± 33 |
| Viscosity (mPa · s) at 0.01 | 6.5E+05 | 1.4E+07 | 2.1E+07 |
| s⁻¹ shear rate | | | |
| Viscosity (mPa · s) at 100 | 4.9E+04 | 5.6E+04 | 6.4E+04 |
| s⁻¹ shear rate | | | |
| Maximum load (MPa) | 2.3 | 0.6 | 0.5 |
| Maximum elongation (%) | 2.2% | 1.9% | 2.6% |
| Young's modulus (MPa) | 123.4 | 42.3 | 23.6 |
| Toughness (MPa) | 0.018 | 0.004 | 0.006 |
| Shore A hardness (7-day | 91 | 89 | 86 |
| cure) | | | |
| Density (lbs/gal) | 13.13 | 12.66 | 12.46 |

| Example # | Ex. 53 | Ex. 54 | Ex. 55 | Ex. 56 |
|---|---|---|---|---|
| Silane resins | | | | |
| Polymer H | 4.0 | 16.0 | 24.0 | 36.0 |
| STP-E 30 | 36.0 | 24.0 | 16.0 | 4.0 |
| Silquest A-171 | 0.9 | 0.9 | 0.9 | 0.9 |
| Fillers | | | | |
| #10 white | 53.0 | 53.0 | 53.0 | 53.0 |
| Thickeners | | | | |
| Aerosil R 805 | 3.0 | 3.0 | 3.0 | 3.0 |
| Additives and | | | | |
| accelerators | | | | |
| Silquest A-171 | 0.90 | 0.90 | 0.90 | 0.90 |
| Silquest A-1120 | 2.00 | 2.00 | 2.00 | 2.00 |
| Neostann U220-H | 0.20 | 0.20 | 0.20 | 0.20 |
| Performance | | | | |
| Compression shear (psi) | 442 ± 102 | 647 ± 89 | 749 ± 173 | 486 ± 101 |
| Viscosity (mPa · s) at | 4.9E+05 | 1.0E+06 | 3.5E+05 | 7.7E+05 |
| 0.01 s⁻¹ shear rate | | | | |
| Viscosity (mPa · s) at | 7.0E+04 | 7.4E+04 | 8.4E+04 | 1.5E+05 |
| 100 s⁻¹ shear rate | | | | |
| Maximum load (MPa) | 2.2 | 3.5 | 3.4 | 3.5 |
| Maximum elongation | 31.3% | 15.1% | 6.9% | 3.4% |
| (%) | | | | |
| Young's modulus (MPa) | 14 | 28 | 51 | 118 |
| Toughness (MPa) | 0.46 | 0.30 | 0.11 | 0.05 |
| Density (lbs/gal) | 12.88 | 12.95 | 13.19 | 13.17 |

Rheology was measured for Ex. 7, Ex. 8, and Ex. 9 after 3 days

The data in Table 5 show that blending a silane functional polyether resin into the system reduces the strength of the silane functional acrylic resin. All raw material quantities are measured in weight %. It has been surprisingly discovered that blending a silane functional polyurethane resin and a silane functional acrylic resin increases the strength of the system relative to individual resin systems (compare to Comp. 7 in Table 3 and Ex. 46 in Table 10 continued). This synergistic improvement was not observed between silane functional polyethers and silane functional acrylics (compare to Table 4).

TABLE 6
Examples of adhesives prepared with various accelerators.
Raw material quantities are measured in weight %.

| Notebook page | | | |
|---|---|---|---|
| Example # | Ex. 25 | Ex. 26 | Ex. 27 |
| Accelerator type | Bismuth | Zinc | None |
| Silane resins | | | |
| Polymer C | 40.0 | 40.0 | 40.2 |
| Silquest A-171 | 0.9 | 0.9 | 0.9 |
| Fillers | | | |
| #10 White | 53.0 | 53.0 | 53.0 |
| Thickeners | | | |
| Aerosil R 805 | 3.0 | 3.0 | 3.0 |
| Additives and accelerators | | | |
| Silquest A-171 | 0.90 | 0.90 | 0.90 |
| Silquest A-1120 | 2.00 | 2.00 | 2.00 |
| K-Kat XK-651 | 0.20 | — | — |
| K-Kat XK-635 | — | 0.20 | — |
| Performance | | | |
| Compression shear (psi) | 261 ± 48 | 194 ± 42 | 209 ± 48 |
| Viscosity (mPa · s) at 0.01 | 8.9E+05 | 8.1E+05 | 6.8E+05 |
| s⁻¹ shear rate | | | |
| Viscosity (mPa · s) at 100 | 3.2E+04 | 3.0E+04 | 2.9E+04 |
| s⁻¹ shear rate | | | |
| Maximum load (MPa) | 1.72 | 1.69 | 1.36 |
| Maximum elongation (%) | 3.22% | 3.42% | 3.01% |
| Young's modulus (MPa) | 58.8 | 54.0 | 49.8 |
| Toughness (MPa) | 0.022 | 0.022 | 0.016 |
| Shore A hardness (7-day | 90 | 90 | 93 |
| cure) | | | |
| Density (lbs/gal) | 12.92 | 12.93 | 13.03 |

The data in Table 6 illustrate that the silane functional acrylics can be cured with many types of accelerators including organic and metal-based materials. Note that Silquest A-1120 is an aminosilane and an amine-based accelerator.

TABLE 7
Examples of adhesives prepared with various comparative and experimental resins.

| Example # | Comp. 15 | Comp. 16 | Comp. 17 | Comp. 18 | Comp. 19 | Comp. 20 | Comp. 21 |
|---|---|---|---|---|---|---|---|
| Silane resins | | | | | | | |
| SAX 400 | 99.50 | — | — | — | — | — | — |
| MA 480 | — | 99.50 | — | — | — | — | — |
| STP-E 10 | — | — | 99.50 | — | — | — | — |
| SPUR + | — | — | — | 99.50 | — | — | — |
| 1015LM | | | | | | | |
| Tegopac seal | — | — | — | — | 99.50 | — | — |
| 100 | | | | | | | |
| SAX 350 | — | — | — | — | — | 99.50 | — |
| STP-E 30 | — | — | — | — | — | — | 99.50 |
| Polymer A | — | — | — | — | — | — | — |
| Polymer B | — | — | — | — | — | — | — |
| Polymer C | — | — | — | — | — | — | — |
| Additives and accelerators | | | | | | | |
| Neostann | 0.50 | 0.50 | 0.50 | 0.50 | 0.50 | 0.50 | 0.50 |
| U220-H | | | | | | | |
| Performance | | | | | | | |
| Compression | 73 ± 12 | 104 ± 20 | 125 ± 15 | 85 ± 14 | 31 ± 7 | 51 ± 9 | 109 ± 12 |
| shear (psi) | | | | | | | |
| Viscosity | 4.6E+04 | 2.0E+05 | 2.3E+04 | 6.9E+04 | 7.7E+04 | 9.1E+03 | 4.8E+04 |
| (mPa · s) at 1 s⁻¹ | | | | | | | |
| shear rate | | | | | | | |
| Crosslink | 0.14 | 0.1 | 0.19 | 0.1 | 0.03 | 0.1 | 0.21 |
| density | | | | | | | |
| (mmol/cc) | | | | | | | |
| Adhesive Tg | −54 | −41, −8 | −52 | −51 | −51 | −54 | −51 |
| (° C.) | | | | | | | |

| Example # | Ex. 28 | Ex. 29 | Ex. 30 |
|---|---|---|---|
| Silane resins | | | |
| SAX 400 | — | — | — |
| MA 480 | — | — | — |
| STP-E 10 | — | — | — |
| SPUR + | — | — | — |
| 1015LM | | | |
| Tegopac seal | — | — | — |
| 100 | | | |
| SAX 350 | — | — | — |
| STP-E 30 | — | — | — |
| Polymer A | 99.50 | — | — |
| Polymer B | — | 99.50 | — |
| Polymer C | — | — | 99.50 |
| Additives and accelerators | | | |
| Neostann | 0.50 | 0.50 | 0.50 |
| U220-H | | | |
| Performance | | | |
| Compression | 250 ± 41 | 163 ± 34 | 84 ± 30 |
| shear (psi) | | | |
| Viscosity | 7.2E+04 | 1.4E+04 | 1.0E+04 |
| (mPa · s) at 1 | | | |
| s⁻¹ shear rate | | | |
| Crosslink | 2.29 | 1.53 | 0.64 |
| density | | | |
| (mmol/cc) | | | |
| Adhesive Tg | 16 | −2 | −8 |
| (° C.) | | | |

Raw material quantities are measured in weight %.

The data in Table 7 illustrates that the silane functional acrylics can produce a stronger compression shear joint than existing polyether-based commercial resins even as the adhesives were simplified to comprise only silane resin and accelerator.

TABLE 8
Examples of adhesives prepared with various silane
monomer loading in the acrylic resins. Raw material
quantities are measured in weight %.

| | | | Ex. 52 |
|---|---|---|---|
| Example # | Ex. 45 | Ex. 51 | (Comparative) |
| Resin silane monomer | 30% | 3% | 1% |
| (wt %) | | | |
| Silane resins | — | | |
| Polymer G | 40 | — | — |
| Polymer M | — | 40 | — |
| Polymer N | — | — | 40 |
| Silquest A-171 | 0.9 | 0.9 | 0.9 |
| Fillers | | | |
| #10 White | 53 | 53 | 53 |
| Thickeners | | | |
| Aerosil R 805 | 3 | 3 | 3 |
| Additives and | | | |
| accelerators | | | |
| Silquest A-171 | 0.9 | 0.9 | 0.9 |
| Silquest A-1120 | 2 | 2 | 2 |
| Neostann U220-H | 0.2 | 0.2 | 0.2 |
| Performance | | | |
| Compression shear (psi) | 632 ± 153 | 129 ± 5 | 10 ± 1 |
| Viscosity (mPa · s) at | 4.4E+05 | 9.3E+05 | 1.4E+06 |
| 0.01 s⁻¹ shear rate | | | |
| Viscosity (mPa · s) at 100 | 4.1E+04 | 3.6E+05 | 4.9E+05 |
| s⁻¹ shear rate | | | |
| Maximum load (MPa) | 3.6 | 0.8 | ND |
| Maximum elongation | 1.8% | 25.0% | |
| (%) | | | |
| Young's modulus | 223 | 1 | |
| (MPa) | | | |
| Toughness (MPa) | 0.03 | 0.09 | |
| Density (lbs/gal) | 13.19 | 13.21 | 13.15 |

ND = not determined, sample uncured.

These data show that adhesive compositions will cure to produce moderate to excellent shear strength with silane monomer loadings down to 5 wt % and up to 30 wt %.

TABLE 9
Examples of adhesives prepared with silane acrylic-polyurethane
copolymer. Raw material quantities are measured in weight %.

| Example # | Ex. 45 |
|---|---|
| Silane resins | |
| Polymer Q | 40 |
| Silquest A-171 | 0.9 |
| Fillers | |
| #10 White | 53 |
| Thickeners | |
| Aerosil R 805 | 3 |
| Additives and accelerators | |
| Silquest A-171 | 0.9 |
| Silquest A-1120 | 2 |
| Neostann U220-H | 0.2 |
| Performance | |
| Compression shear (psi) | 514 ± 163 |
| Viscosity (mPa · s) at 0.01 | 1.20E+07 |
| s⁻¹ shear rate | |
| Viscosity (mPa · s) at 100 | 1.89E+05 |
| s⁻¹ shear rate | |
| Maximum load (MPa) | 2.04 |
| Maximum elongation (%) | 5.06% |
| Young's modulus (MPa) | 50.8 |
| Toughness (MPa) | 0.051 |
| Density (lbs/gal) | 13.13 |

Example 45 shows that improved strength can be achieved using a hybrid silane acrylic-polyurethane copolymer in addition to using a blended two resin system (refer to Table 5).

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any all equivalents thereof.

1. A resin composition comprising:
a (meth)acrylic polymer comprising at least one pendant silane functional group and a silane functional group equivalent weight of 500 g/eq to 9,000 g/eq.

2. The resin composition of claim 1, wherein the (meth)acrylic polymer comprises a silane functional group equivalent weight of 1,000 g/eq to 8,000 g/eq.

3. The resin composition of claim 1, wherein the (meth)acrylic polymer further comprises a non-silane acrylic functional group.

4. The resin composition of claim 1, wherein the (meth)acrylic polymer comprises the silane functional group in an amount of 1% by weight to 50% by weight, based on total Mw of the (meth)acrylic polymer and/or wherein the (meth)acrylic polymer comprises the silane functional group in an amount of 0.2 mol % to 40 mol % based on total moles of functional groups of the (meth)acrylic polymer.

5. (canceled)

6. The resin composition of claim 3, wherein the (meth)acrylic polymer comprises the non-silane acrylic functional group in an amount of 50% by weight to 99% by weight based on total weight of the (meth)acrylic polymer and/or wherein the (meth)acrylic polymer comprises the non-silane acrylic functional group in an amount of 60 mol % to 99.8 mol % based on total moles of functional groups of the (meth)acrylic polymer.

7. (canceled)

8. The resin composition of claim 1, wherein the (meth)acrylic polymer comprises an Mw of 1,500 g/mol to 35,000 g/mol measured by gel permeation chromatography (GPC) using polystyrene standards and waters Styragel column in THF solvent.

9. The resin composition of claim 1, wherein the (meth)acrylic polymer comprises a reaction product of reactants comprising (i) a silane functional monomer or polymer comprising the residue of a silane functional monomer and (ii) a non-silane acrylic monomer or polymer comprising the residue of a non-silane acrylic monomer.

10. The resin composition of claim 1, wherein the resin composition comprises an uncured Tg of −60° C. to 30° C. as measured by dynamic mechanical analysis.

11-12. (canceled)

13. The resin composition of claim 9, wherein the silane functional monomer comprises a trimethoxysilane and/or a triethoxysilane.

14. (canceled)

15. The resin composition of claim 1, wherein the (meth)acrylic polymer is substantially free of nitrogen and/or a residue of an ether and/or a urethane.

16-19. (canceled)

20. The resin composition of claim 1, wherein the resin composition comprises the (meth)acrylic polymer in an amount of 10 percent by weight to 90 percent by weight based on total weight of the resin composition.

21. A coating composition comprising:
the resin composition of claim 1; and
an accelerator.

22. A coating composition comprising:
a resin composition comprising a (meth)acrylic polymer comprising at least one pendant silane functional group; and
an accelerator.

23. The coating composition of claim 22, wherein the coating composition is formulated as an adhesive composition and/or a sealant composition.

24. The coating composition of claim 22, wherein the coating composition comprises the accelerator in an amount of 0.0001% by weight to 10% by weight based on total weight of the coating composition.

25-26. (canceled)

27. The coating composition of claim 22, further comprising a filler, a thixotrope, and/or a polyurethane polymer.

28-29. (canceled)

30. The coating composition of claim 27, wherein the coating composition comprises the polyurethane polymer in an amount of 3 percent by weight to 90 percent by weight based on total weight of the coating composition.

31-36. (canceled)

37. An article comprising:
a first substrate comprising a coating formed on a portion of a surface by application of the coating composition of claim 22.

38-40. (canceled)

41. The resin composition of claim 1, wherein the (meth)acrylic polymer comprises 1% by weight to 50% by weight of the silane functional group based on total Mw of the (meth)acrylic polymer.

42. The resin composition of claim 1, wherein the (meth)acrylic polymer comprises 0.2 mol % to 40 mol % of the silane functional group in an amount of 0.2 mol % to 40 mol % based on total moles of functional groups of the (meth)acrylic polymer.
